(19) United States
(12) Patent Application Publication
(10) Pub. No.: US 2016/0026630 A1
(43) Pub. Date: Jan. 28, 2016

(54) CHARACTER SEQUENCE MAP GENERATING APPARATUS, INFORMATION SEARCHING APPARATUS, CHARACTER SEQUENCE MAP GENERATING METHOD, INFORMATION SEARCHING METHOD, AND COMPUTER PRODUCT

(71) Applicant: FUJITSU LIMITED, Kawasaki-shi (JP)

(72) Inventors: Masahiro Kataoka, Kawasaki-shi (JP); Tomoki Nagase, Kawasaki-shi (JP); Takashi Tsubokura, Tokyo (JP)

(21) Appl. No.: 14/835,053

(22) Filed: Aug. 25, 2015

Related U.S. Application Data
(63) Continuation of application No. 12/362,183, filed on Jan. 29, 2009, now abandoned.

(30) Foreign Application Priority Data
May 29, 2008 (JP) 2008-141734

(51) Int. Cl. G06F 17/30

(52) U.S. Cl. CPC G06F 17/3043; G06F 17/30914

(57) ABSTRACT

A computer-readable recording medium stores therein a sequence-map generating program that causes a computer to execute extracting from files that include character strings written therein, a word having q (q≧2) characters; extracting from the word extracted at the extracting the word, consecutive characters from a character position s-th (1≦s≦q−r+1) from a head of the word to a character position determined by a number of characters r (r≦q); and generating, for each character position s-th from the head, a consecutive-character sequence map including a flag row that indicates, for each file, whether a file includes the consecutive characters extracted at the extracting the consecutive characters.

### CROSS-REFERENCE TO RELATED APPLICATIONS

This application is a Continuation of application Ser. No. 12/362,183, filed Jan. 29, 2009.

This application is based upon and claims the benefit of priority from the prior Japanese Patent Application No. 2008-141734, filed on May 29, 2008, the entire contents of which are incorporated herein by reference.

### FIELD

The embodiments discussed herein are related to character sequence map generation and an information searching.

### BACKGROUND

International Publication No. 2006-123448 discloses a conventional technique of achieving high-speed full text searches by disassembling a search character string into respective characters included in the character string and performing AND calculation of flag rows in maps where the disassembled characters appear, thereby narrowing down the files to be searched. For example, when a standard Japanese language dictionary is searched, one file includes in the order of approximately 4,000 characters and if the files to be searched are narrowed to approximately 5,000 files, the probability of a given kanji character being included is 1/13 on average.

The probability for a search character string consisting of one character is 1/13, consisting of two characters is 1/169, and consisting of three characters is 1/2197. Hence, search speed is improved substantially, although processing of character incidence maps is necessary. For example, when full text search on a search character string of “ [symbol] ” is performed, the search time is 1.5 second (0.2 second at the second round), which means a search speed approximately 170 times faster than the original search speed is achieved. The use of three types of character maps narrows down the number of files to be searched from 5151 to 32, which consequently puts 28 hit items on display. Relevant techniques are also disclosed in Japanese Patent Nos. 3333549, 3046221, and 3263963.

According to the conventional techniques above, however, scores of kanji characters having incidence frequencies exceeding 50%, such as “ [symbol] ” and “ [symbol] ”, are present in searching. As a result, full text search on a search character string of “ [symbol] ” takes 35 seconds (13 seconds at the second round), which is merely two times as fast as the original search speed. The number of files to be searched is narrowed down from 5151 to 3312 through flag rows for the two characters, which consequently puts 158 hit items on display. If a character string composed of frequently appearing characters is searched for as a search keyword, there is a low probability of identifying a file, leading to reduced search precision, where unnecessary open/read processing also reduces the search speed.

### SUMMARY

According to an aspect of an embodiment, a computer-readable recording medium stores therein a sequence-map generating program that causes a computer to execute: extracting from files that include character strings written therein, a word having q (q≧2) characters; extracting from the word extracted at the extracting the word, consecutive characters from a character position s-th (1≦s≦q−r+1) from a head of the word to a character position determined by a number of characters r (r≦q); and generating, for each character position s-th from the head, a consecutive-character sequence map including a flag row that indicates, for each file, whether a file includes the consecutive characters extracted at the extracting the consecutive characters.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram of a computer according to an embodiment of the present invention;

FIG. 2 is a block diagram of a functional configuration of a search system;

FIG. 3 is a schematic of contents to be searched;

FIG. 4 is a schematic of keyword data;

FIG. 5 is a schematic of a single-character map;

FIG. 6 is a schematic of a consecutive-character sequence map group;

FIG. 7 is a schematic of a head consecutive-character sequence map Mh1, 2;

FIG. 8 is a schematic of an end consecutive-character sequence map Me1, 2;

FIG. 9 is a schematic of an example of generation of a head consecutive-character sequence map group;

FIG. 10 is a schematic of an example of generation of an end consecutive-character sequence map group;

FIG. 11 is a schematic of an example of file narrowing down using the head consecutive-character sequence map group;

FIG. 12 is a schematic of an example of file narrowing down using the end consecutive-character sequence map group;

FIG. 13 is a block diagram of a first functional configuration of a map generating apparatus;

FIG. 14 is a schematic of a converting process by a foreign character converting unit;

FIG. 15 is a schematic of an example of an entry in a single-character map for converted codes acquired by the converting process depicted in FIG. 14;

FIG. 16 is a block diagram of a second functional configuration of the map generating apparatus;

FIG. 17 is a schematic of an integrating process by an integrating unit;

FIG. 18 is a schematic of a keyword search process by a keyword searching unit depicted in FIG. 16;

FIG. 19 is a schematic of a code converting process on a kana/kanji character string, etc., by a converting unit depicted in FIG. 16;

FIG. 20 is a schematic of an example of an entry of converted codes acquired by the converting process depicted in FIG. 19;

FIG. 21 depicts a code converting process on an alphanumeric character string, etc. by the converting unit depicted in FIG. 16;

FIG. 22 is a schematic of an example of an entry of the converted codes acquired by the converting process depicted in FIG. 21, in a head consecutive characters map Mhs, 3;

FIG. 23 is a block diagram of a first functional configuration of an information searching apparatus;

FIG. 24 is a block diagram of a second functional configuration of the information searching apparatus;

FIG. 25 is a schematic of a result of counting a reference frequency for each consecutive-character sequence map;

FIG. 26 is a flowchart of an overall procedure by the search system;

FIG. 27 is a flowchart of a map generating process;

FIG. 28 is a flowchart of a single-character map generating process;

FIG. 29 is a flowchart of a single character registering process;

FIG. 30 is a flowchart of the code converting process on a single foreign character by byte calculation (step S2906);

FIG. 31 is a flowchart of a code converting process on a single foreign character by digit calculation;

FIGS. 32 and 33 are flowcharts of a consecutive-character sequence map generating process for r consecutive characters;

FIGS. 34 and 35 are flowcharts of a head consecutive-character sequence map generating process;

FIG. 36 is a flowchart of a first extracted r consecutive characters entry process on the head consecutive-character sequence map Mhs, r;

FIG. 37 is a flowchart of a second extracted r consecutive characters entry process on the head consecutive-character sequence map Mhs, r;

FIG. 38 is a flowchart of a code converting process on a kana/kanji character string, etc. by byte calculation;

FIG. 39 is a flowchart of a code converting process on a kana/kanji character, etc. by digit calculation;

FIG. 40 is a flowchart of a code converting process on an alphanumeric character string, etc. by byte calculation;

FIG. 41 is a flowchart of a code converting process on an alphanumeric character string, etc. by digit calculation;

FIGS. 42 and 43 are flowcharts of an end consecutive-character sequence map generating process;

FIG. 44 is a flowchart of a first extracted r consecutive characters entry process on the end consecutive-character sequence map Met, r;

FIG. 45 is a flowchart of a second extracted r consecutive characters entry process on the end consecutive-character sequence map Met, r;

FIG. 46 is a flowchart of an initializing process depicted in FIG. 26;

FIG. 47 is a flowchart of an integrated head consecutive-character sequence map group generating process;

FIG. 48 is a flowchart of an integrated end consecutive-character sequence map group generating process;

FIG. 49 is a flowchart of an input process depicted in FIG. 26;

FIG. 50 is a flowchart of a file narrowing down process;

FIG. 51 is a flowchart of the file narrowing down process using the single-character map;

FIG. 52 is a flowchart of the file narrowing down process using a consecutive-character sequence map;

FIG. 53 is a flowchart of a first file narrowing down process using the head consecutive-character sequence map Mhs, r;

FIG. 54 is a flowchart of a first file narrowing down process using the end consecutive-character sequence map Met, r;

FIG. 55 is a flowchart of a second file narrowing down process using the head consecutive-character sequence map Mhs, r;

FIG. 56 is a flowchart of a second file narrowing down process using the end consecutive-character sequence map Met, r; and

FIG. 57 is a flowchart of the code converting processes depicted in FIGS. 55 and 56.

### DESCRIPTION OF EMBODIMENT(S)

Preferred embodiments of the present invention will be explained with reference to the accompanying drawings.

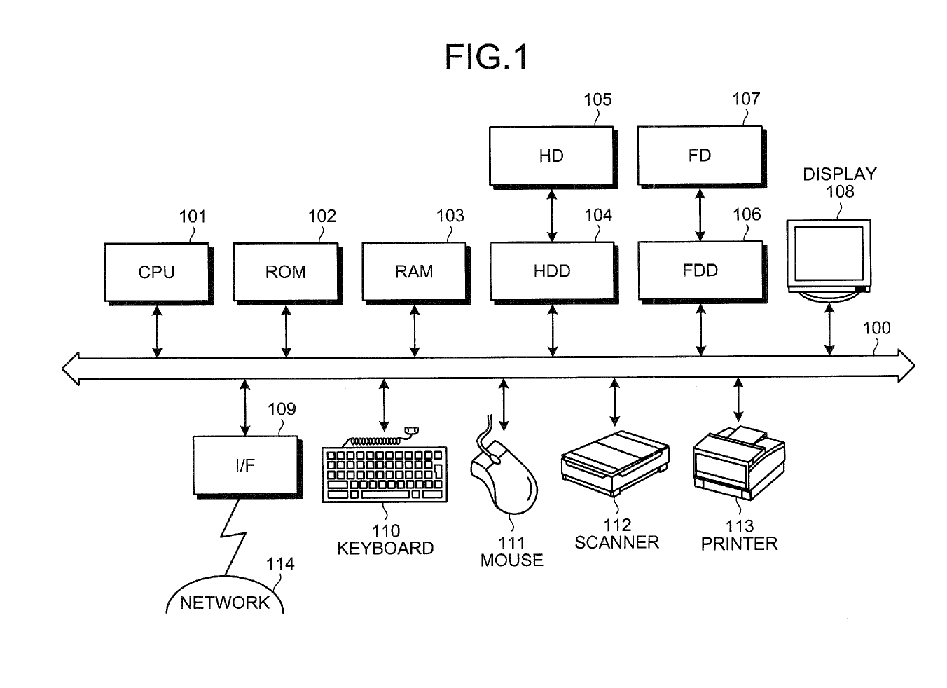

FIG. 1 is a block diagram of a computer according to an embodiment of the present invention. As depicted in FIG. 1, the computer includes a central processing unit (CPU) 101, a read-only memory (ROM) 102, a random access memory (RAM) 103, a hard disc drive (HDD) 104, a hard disc (HD) 105, a flexible disc drive (FDD) 106, a flexible disc (FD) 107 as an example of a removal recording medium, a display 108, an interface (I/F) 109, a keyboard 110, a mouse 111, a scanner 112, and a printer 113, connected to one another by way of a bus 100.

The CPU 101 governs overall control of the computer. The ROM 102 stores therein programs such as a boot program. The RAM 103 is used as a work area of the CPU 101. The HDD 104, under the control of the CPU 101, controls the reading/writing of data from/to the HD 105. The HD 105 stores therein the data written under control of the HDD 104.

The FDD 106, under the control of the CPU 101, controls reading/writing of data from/to the FD 107. The FD 107 stores therein the data written under control of the FDD 106, the data being read by the computer.

In addition to the FD 107, a removable recording medium may include a compact disc read-only memory (CD-ROM), compact disc-recordable (CD-R), a compact disc-rewritable (CD-RW), a magneto optical disc (MO), a Digital Versatile Disc (DVD), or a memory card. The display 108 displays a cursor, an icon, a tool box, and data such as document, image, and function information. The display 108 may be, for example, a cathode ray tube (CRT), a thin-film-transistor (TFT) liquid crystal display, or a plasma display.

The I/F 109 is connected to a network 114 such as the Internet through a telecommunications line and is connected to other devices by way of the network 114. The I/F 109 manages the network 114 and an internal interface, and controls the input and output of data from/to external devices. The I/F 109 may be, for example, a modem or a local area network (LAN) adapter.

The keyboard 110 is equipped with keys for the input of characters, numerals, and various instructions, and data is entered through the keyboard 110. The keyboard 110 may be a touch-panel input pad or a numeric keypad. The mouse 111 performs cursor movement, range selection, and movement, size change, etc., of a window. The mouse 111 may be a trackball or a joystick provided the trackball or joystick has similar functions as a pointing device.

The scanner 112 optically reads an image and takes in the image data into the computer. The scanner 112 may have an optical character recognition (OCR) function as well. The printer 113 prints image data and document data. The printer 113 may be, for example, a laser printer or an ink jet printer.

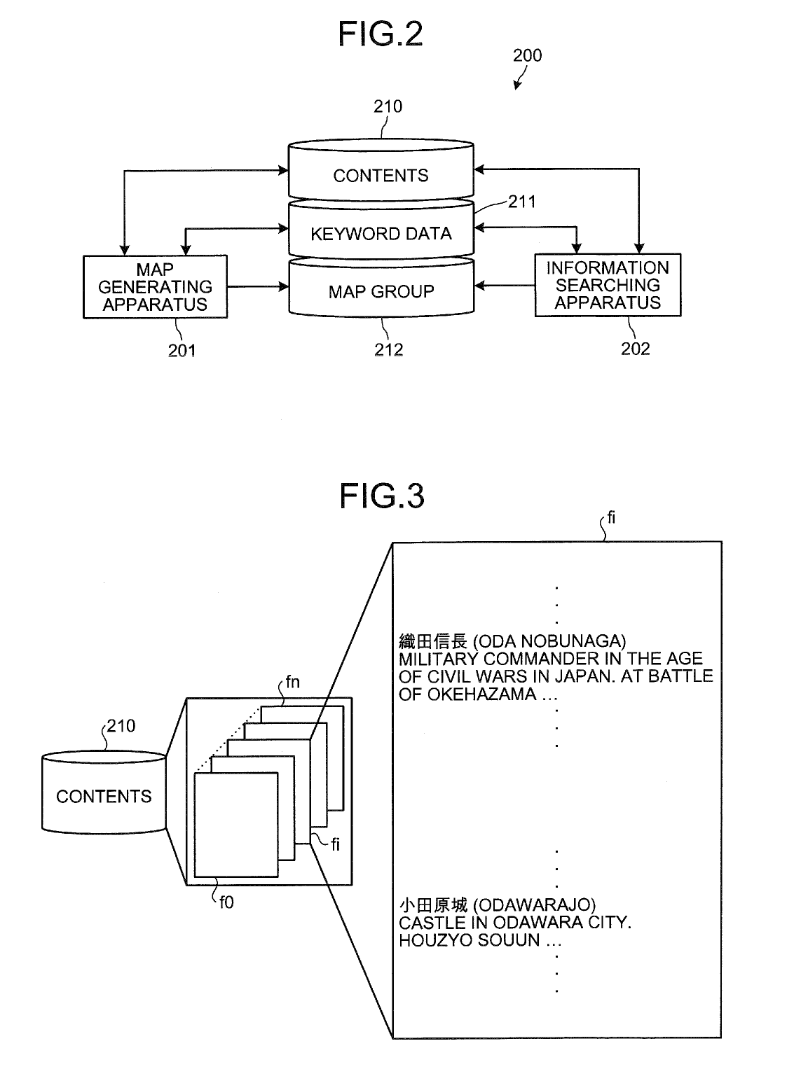

FIG. 2 is a block diagram of a functional configuration of a search system. In FIG. 2, a search system 200 includes a map generating apparatus 201, an information searching apparatus 202, contents 210 that are to be searched, keyword data 211, and a map group 212. The map generating apparatus 201 generates the map group 212. The map generating apparatus 201 is implemented by the hardware depicted in FIG. 1. The information searching apparatus 202 searches the contents 210 for a character string matching or related to a search character string. The information searching apparatus 202 is implemented by the hardware depicted in FIG. 1. The map generating apparatus 201 and the information searching apparatus 202 may provided as a single integrated apparatus or as separate apparatuses.

The contents 210 are contents to be searched and include written character strings, like the contents of a dictionary, glossary, etc. The keyword data 211 is a table depicting a list of character strings used as keywords in the contents 210. The map group 212 represents various maps (single-character maps and consecutive-character sequence maps described hereinafter).

FIG. 3 is a schematic of the contents 210, which includes files f0 to fn. Each file fi is, for example, data written in HyperText Markup Language (HTML) format, eXtensible Markup Language (XML) format, etc. describing various character strings. For example, when the contents 210 are the contents of a standard Japanese language dictionary, the contents 210 includes approximately 5,000 files, each file including approximately 4,000 characters.

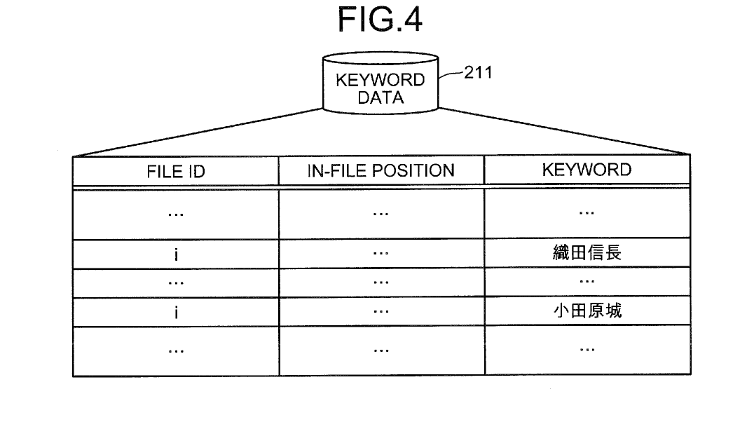

FIG. 4 is a schematic of the keyword data 211. The keyword data 211 includes a keyword, a file ID(s) indicative of the file(s) fi including the keyword, and the position of the keyword within the file(s) fi. When a keyword is searched for, a portion corresponding to the search keyword in a file fi including the keyword is cut out based on the file ID and the position of the keyword in within the file fi, and is displayed on a display.

In the embodiment, a map including a flag row for each file fi is generated, the flag row indicating whether a given character is present in the files f0 to fn written in HTML or XML format and making up the contents 210, such as a dictionary. Before the start of processing to search the files f0 to fn for a character string matching or related to a search character string, the files fi are narrowed down to the files fi that include a character making up the search character string, based on the map generated. Consequently, not all of the files f0 to fn are searched, only the narrowed down files fi are searched, thereby improving the hit rate and search speed. The map includes a single-character map and a consecutive-character sequence map.

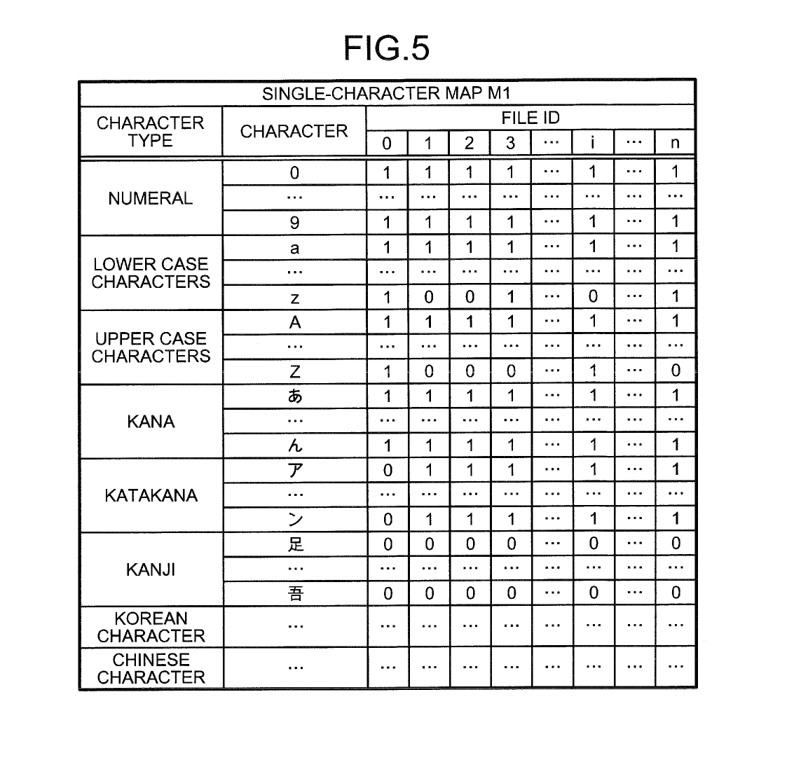

FIG. 5 is a schematic of a single-character map. A single-character map M1 is a map composed of flag rows indicating, according to each file fi, whether given single-characters are present in the files f0 to fn. In the single-character map M1, character type indicates the type of single-character appearing in the contents 210. Types of single-characters include, for example, numerals, modern Latin lowercase characters, modern Latin uppercase characters, kana, katakana, kanji, and characters of other languages, such as Korean and Chinese. Modern Latin characters and katakana characters include one-byte characters and two-byte characters, which may be handled separately or may be handled together (the same applies with respect to a consecutive-character sequence map described hereinafter).

File ID is information uniquely identifying each of the files f0 to fn. A bit value of “0” or “1” corresponding to each file ID is a flag indicating the presence/absence of a given character. A bit value of “0” for a file fi indicates that the given character is not present in the file fi, while a bit value of “1” for the file fi indicates that the given character is present in the file fi. A sequential arrangement of the data of the flags according to ID is referred to as a flag row (the same applies with respect to a consecutive-character sequence map). A combination of a character and a flag row is referred to as an entry.

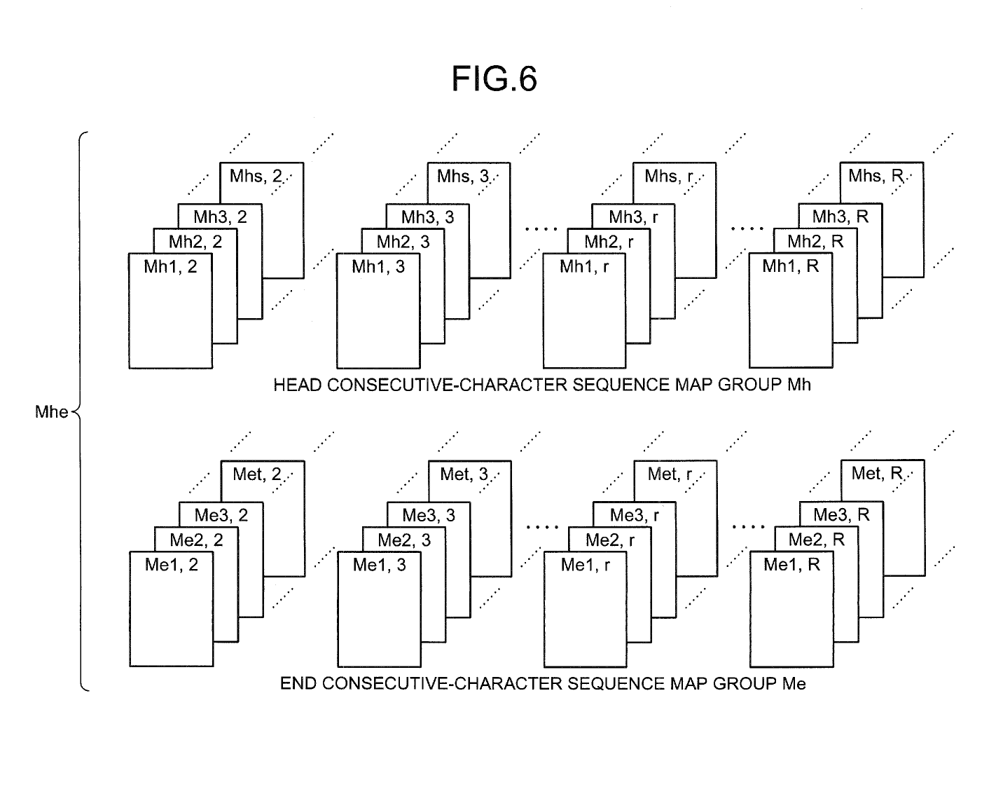

FIG. 6 is a schematic of a consecutive-character sequence map group. The consecutive-character sequence map group Mhe is a group of maps each including flag rows indicating the presence/absence of consecutive characters in each of the files f0 to fn. Consecutive characters are a character string consisting of a series of characters. A combination of consecutive characters and a flag row is referred to as an entry.

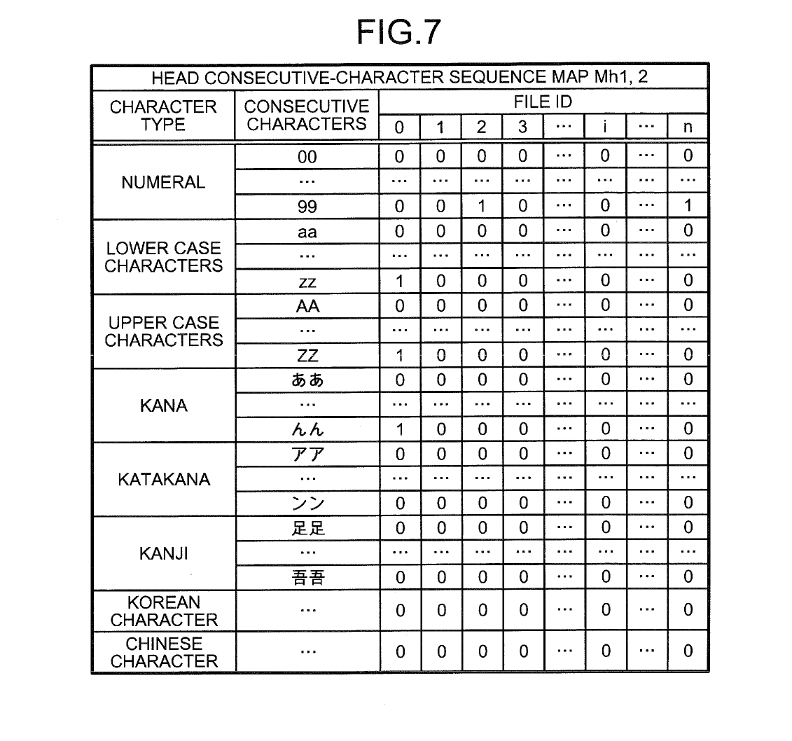

The consecutive character sequence map group Mhe is divided into a head consecutive-character sequence map group Mh and an end consecutive-character sequence map group Me. The head consecutive-character sequence map group Mh is a group of head consecutive-character sequence maps Mhs, r. The end consecutive-character sequence map group Me is a group of end consecutive-character sequence maps Met, r. A head consecutive-character sequence map Mhs, r is a consecutive-character sequence map that when the number of characters of a word to be searched for is q, expresses the presence/absence of given consecutive characters consecutive from a character position s-th (1≦s≦q−r+1) from the head of the word to a character position determined by a given number of characters r (r≦q). The upper limit of the number of characters r is R. FIG. 7 is a schematic of a head consecutive-character sequence map Mh1, 2.

In a head consecutive-character sequence map Mhs, r, consecutive characters starting from an s-th character from the head toward the end is given as a reference. For example, when a head consecutive-character sequence map Mhs, r (r=2) is generated for a word “ [symbol] ”, a flag row for consecutive characters “ [symbol] ” is recorded on the head consecutive-character sequence map Mh1, 2, a flag row for consecutive characters “ [symbol] ” is recorded in a head consecutive-character sequence map Mh2, 2, and a flag row for consecutive characters “ [symbol] ” is recorded in a head consecutive-character sequence map Mh3, 2.

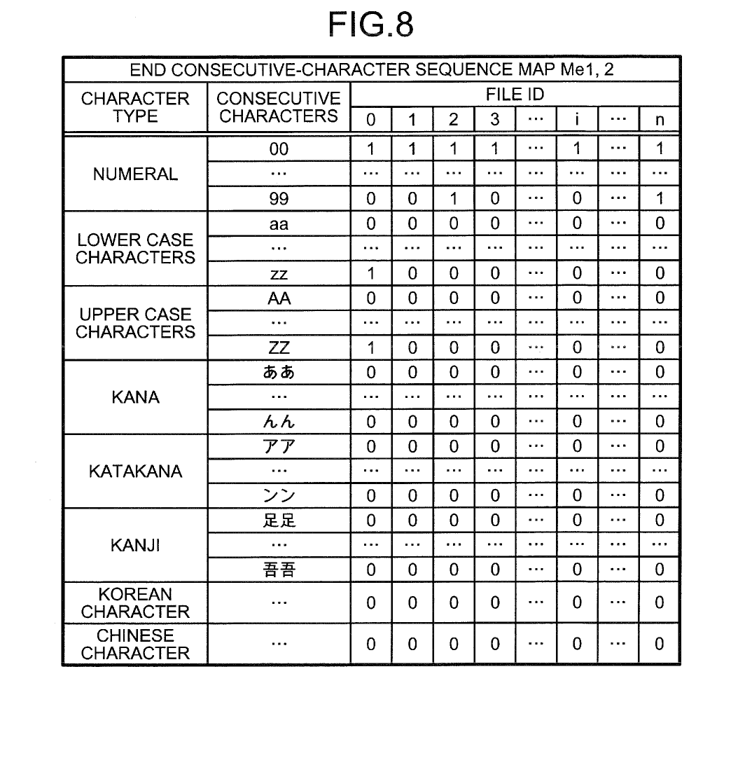

An end consecutive-character sequence map Met, r is a consecutive-character sequence map that when the number of characters of a word to be searched for is q, expresses the presence/absence of consecutive characters consecutive from a character position t-th (1≦t≦q−r+1) from the end of the word to a character position determined by a given number of characters r (r≦q). FIG. 8 is a schematic of an end consecutive-character sequence map Me1, 2.

In an end consecutive-character sequence map Met, r, consecutive characters starting from a t-th character from the end toward the head is given as a reference. For example, when an end consecutive-character sequence map Met, r (r=2) is generated for the word “ [symbol] ”, a flag row for consecutive characters “ [symbol] ” is recorded in the end consecutive-character sequence map Me1, 2, a flag row for consecutive characters “ [symbol] ” is recorded in a head consecutive-character sequence map Me2, 2, and a flag row for consecutive characters “ [symbol] ” is recorded in a head consecutive-character sequence map Me3, 2.

In the generation of a consecutive-character sequence map group, words are extracted sequentially from a file fi, and consecutive characters from the head side character position s or the end side character position t to the position determined by a given number of characters r are cut out sequentially from each extracted word and the value of the flag for a file ID i in a flag row is changed from “0” to “1”. This process is performed sequentially on all files from the file f0 to the file fn n-th from the file fl to generate the consecutive-character sequence map groups Mh and Me depicted in FIG. 6. A case where an English word “beautiful” is written in the file fi and the number of characters r is 2 will then be described.

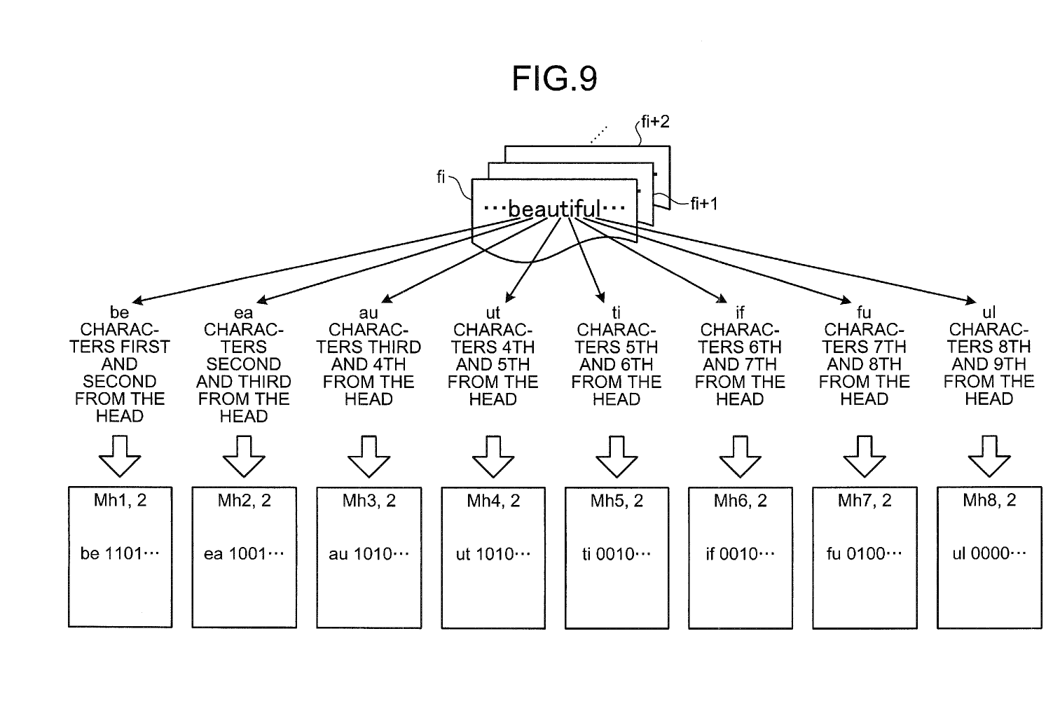

FIG. 9 is a schematic of an example of generation of the head consecutive-character sequence map group Mh. When “beautiful” is extracted from a file fi, consecutive characters “be”, “ea”, “au”, “ut”, “ti”, “if”, “fu”, and “ul” corresponding to the character position s are cut out sequentially from the head. In each of the head consecutive-character sequence maps Mh1, 2 to Mh8, 2, the value of the flag for the file ID i is changed from “0” to “1” in the flag row for the consecutive characters corresponding to the character position s.

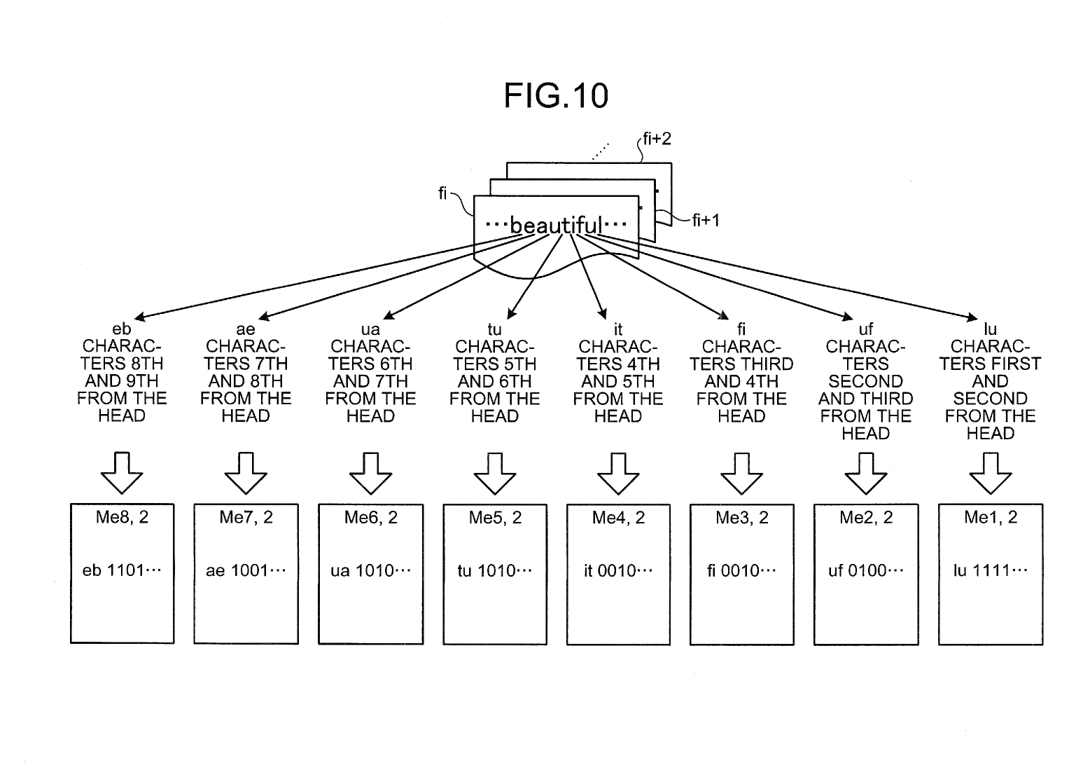

FIG. 10 is a schematic of an example of generation of the end consecutive-character sequence map group Me. When “beautiful” is extracted from the file fi, consecutive characters “lu”, “uf”, “fi”, “it”, “tu”, “ua”, “ae”, and “eb” corresponding to the character position t are cut out sequentially from the end. In each of the end consecutive-character sequence maps Me1, 2 to Me8, 2, the value of the flag for the file ID i is changed from “0” to “1” in the flag row for the consecutive characters corresponding to the character position t.

In a search using the consecutive-character sequence map group Mhe, files fi to be searched are narrowed down before the search. When a search condition for the search is forward-match search, the file narrowing down is performed using the head consecutive-character sequence map group Mh. When the search condition is reverse-match search, the file narrowing down is performed using the end consecutive-character sequence map group Me. A case where a search character string is the English word “beautiful” and the number of characters r is 2, as in the cases of FIGS. 9 and 10, will hereinafter be described.

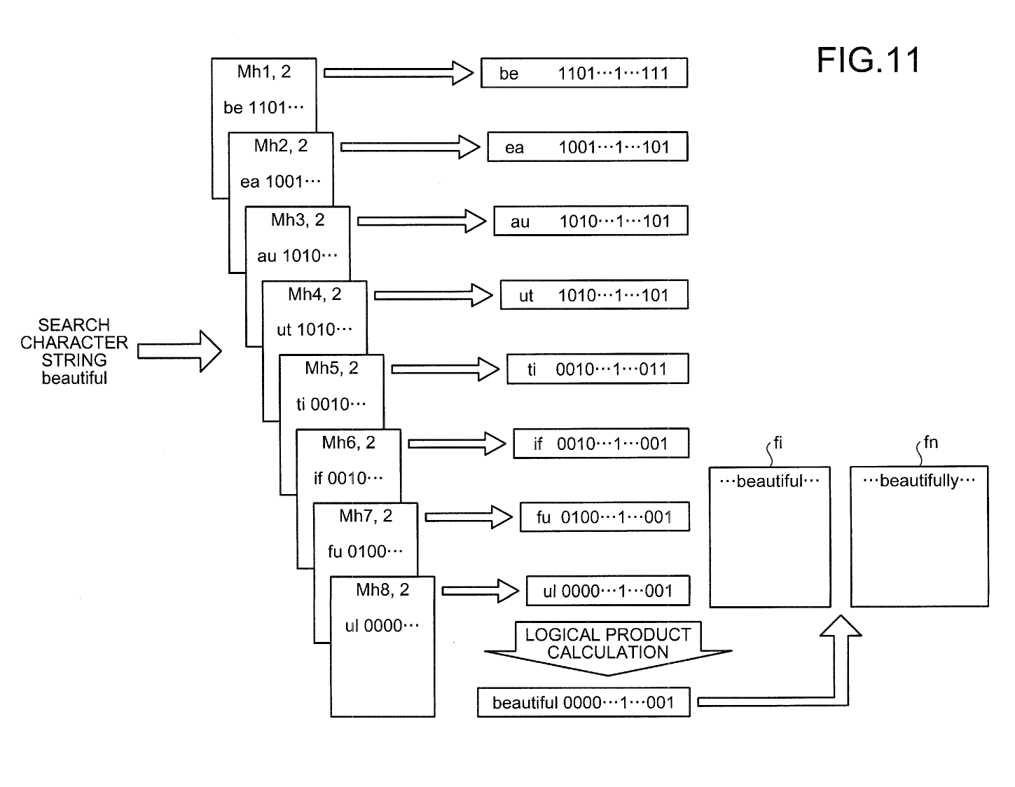

FIG. 11 is a schematic of an example of file narrowing down using the head consecutive-character sequence map group Mh. When the search character string “beautiful” is input, entries of respective consecutive characters “be”, “ea”, “au”, “ut”, “ti”, “if”, “fu”, and “ul” starting from s-th from the head of “beautiful” are extracted, and the logical product of the flag rows of the entries is calculated. A file having a flag “1” resulting from this logical product calculation is equivalent to a file that includes a word having a character string read from its head as “beautiful”. In this example, files are narrowed down to the file fi in which “beautiful” is described and the file fn in which “beautifully” is described. Hence, the files to be searched are found to be the files fi and fn, eliminating any need to search other files.

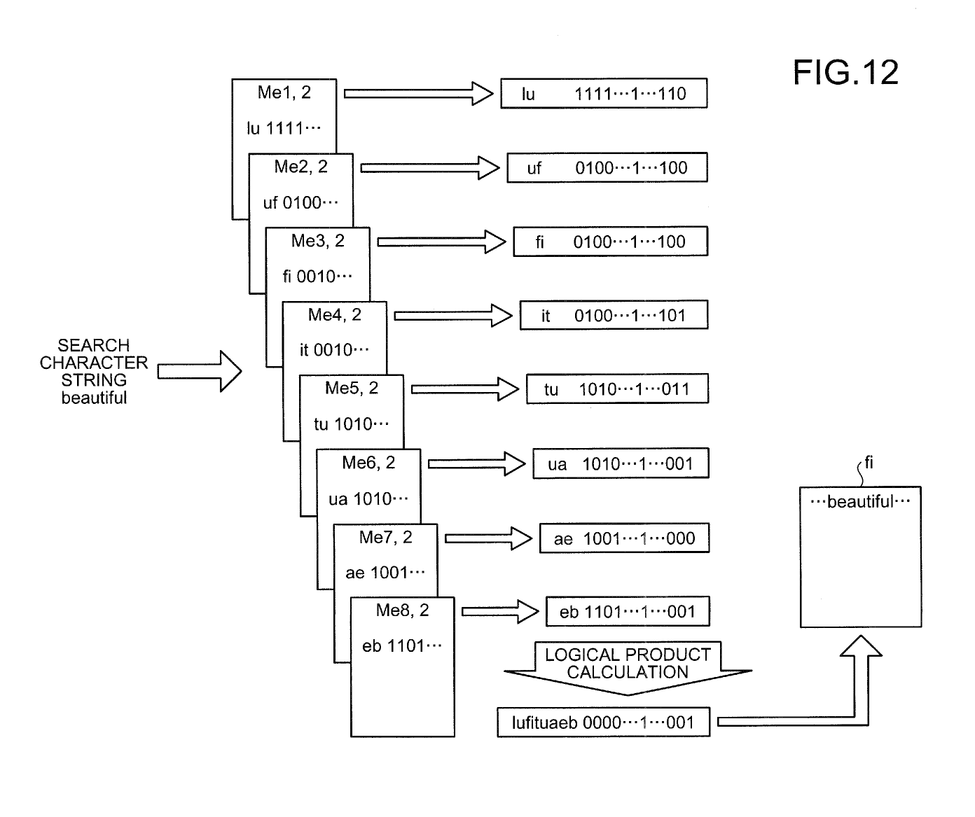

FIG. 12 is a schematic of an example of file narrowing down using the end consecutive-character sequence map group Me. When the search character string “beautiful” is input, entries of respective consecutive characters “lu”, “uf”, “fi”, “it”, “tu”, “ua”, “ae”, and “eb” starting from t-th from the end of “beautiful” are extracted, and the logical product of the flag rows of the entries is calculated. A file with a flag “1” resulting from this logical product calculation is equivalent to a file that includes a word having a character string read from its end as “lufituaeb”. In this example, files are narrowed down to the file fi in which “beautiful” is written. Hence, the file to be searched is found to be the file fi, eliminating any need to search other files.

When file narrowing down is executed as a complete-match search, a logical product of the result of the logical product calculation depicted in FIG. 11 and a result of the logical product calculation depicted in FIG. 12 is further calculated. A file with a flag “1” resulting from this calculation is equivalent to a file that includes a word having a character string read from its head as “beautiful” and a word having a character string read from its end as “lufituaeb”. In this example, files are narrowed down to the file fi. In this manner, through the generation of a consecutive-character sequence map group, a search hit rate is improved and unnecessary file access is reduced, leading to an improvement in search speed.

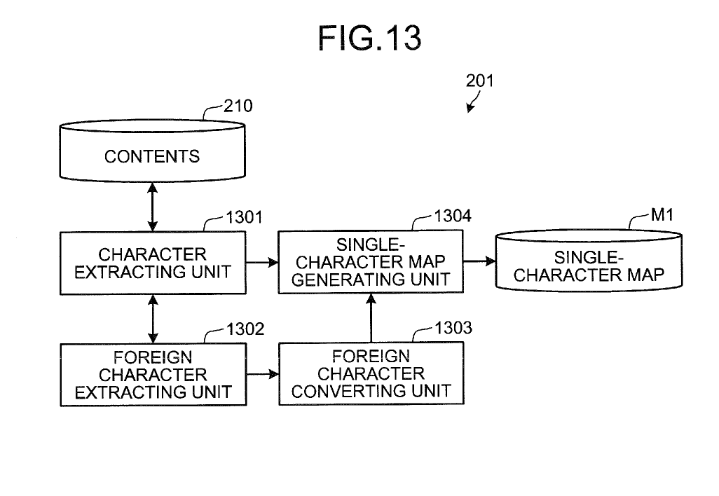

FIG. 13 is a block diagram of a first functional configuration of the map generating apparatus 201. A function of generating the single-character map M1 is described with reference to FIG. 13. As depicted in FIG. 13, the map generating apparatus 201 includes a character extracting unit 1301, a foreign character extracting unit 1302, a foreign character converting unit 1303, and a single-character map generating unit 1304. Respective functions of each unit (the character extracting unit 1301 to the single-character map generating unit 1304) are implemented by the CPU 101 executing a program stored in a memory area such as the ROM 102, the RAM 103, and the HD 105 depicted in FIG. 1.

The character extracting unit 1301 has a function of extracting a character from each of the files fi making up the contents 210. The character extracting unit 1301 extracts a single character at a time. The foreign character extracting unit 1302 has a function of extracting a foreign character when a character to be extracted by the character extracting unit 1301 is a foreign character, such as Korean and Chinese characters. Whether a character is a foreign character can be determined from the character code for the character.

The foreign character converting unit 1303 has a function of coding a foreign character extracted by the foreign character extracting unit 1302 using a one-way function. The foreign character converting unit 1303 generates two different codes by the use of the same one-way function.

The single-character map generating unit 1304 has a function of generating the single-character map M1 including flag rows that, for each of the files f0 to fn, indicate the presence/absence of a single character (one character) extracted by the character extracting unit 1301. Specifically, for example, the flag for the file ID of a file in which a single character appears is changed in value from “0” to “1”. Concerning foreign characters, the foreign character converting unit 1303 provides two different codes for one foreign character, so that a flag row is generated for each code.

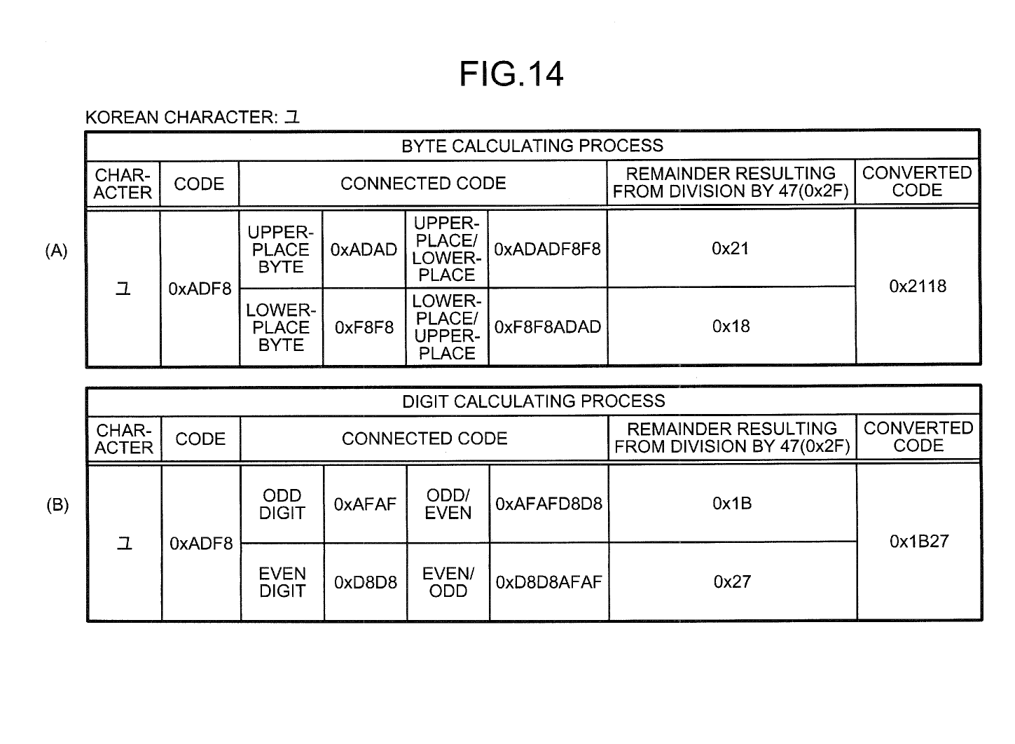

FIG. 14 is a schematic of a converting process by the foreign character converting unit 1303. As depicted in FIG. 14, a code converting process is referred to as byte calculating process (A), and a code converting process referred to as digit calculating process (B). When a consecutive-character sequence map is applied to the UNI code (UTF 16) for Chinese, Korean, etc., a flag row is generated from a value that is given by combining remainders resulting from the division of a UNI code by, for example, “80”. Through this process, a consecutive-character sequence map is reduced in size to a map containing 6,400 (80×80) types of foreign characters. Changing the numerical value of the divisor enables adjustment of the size of the single-character map M1.

Because code conversion is performed with the value of a combination of remainders, different characters may be represented by the same code. For this reason, two types of code conversion are performed to generate a flag row for each of the codes corresponding to one foreign character. Through logical product calculation (crossover processing) of the flag rows, foreign characters can be narrowed down precisely. With reference to FIG. 14, a converting process with respect to a Korean character “ [symbol] ” (character code “0xADF8”) is explained as an example.

In the byte calculating process (A), the character code “0xADF8” is divided into an upper-place byte “AD” and a lower-place byte “F8” to generate an upper-place connected code “0xADAD” by connecting together two upper-place bytes “AD” and to generate a lower-place connected code “0xF8F8” by connecting together two lower-place bytes “F8”.

Then, the upper-place connected code “0xADAD” and the lower-place connected code “0xF8F8” are connected in the sequence of the upper-place connected code followed by the lower-place connected code to generate an upper-place/lower-place connected code “0xADADF8F8”. Alternatively, the upper-place connected code “0xADAD” and the lower-place connected code “0xF8F8” are connected in the sequence of the lower-place connected code followed by the upper-place connected code to generate a lower-place/upper-place connected code “0xF8F8ADAD”.

The generated upper-place/lower-place connected code “0xADADF8F8” and lower-place/upper-place connected code “0xF8F8ADAD” are given to the same function. Specifically, both codes are divided by the same value 47(0x2F) to yield remainders “0x21” and “0x18”. These remainders are connected together to yield a converted code “0x2118” as a result of the byte calculating process.

In the digit calculating process (B), the character code “0xADF8” is divided into odd digits “A” and “F” and even digits “D” and “8” to generate an odd-numbered connected code “0xAEAF” by connecting together two sets of odd digits “A” and “F” and to generate an even-numbered connected code “0xD8D8” by connecting together two sets of even digits “D” and “8”.

Then, the odd-numbered connected code “0xAFAF” and the even-numbered connected code “0xD8D8” are connected in the sequence of the odd-numbered connected code followed by the even-numbered connected code to generate an odd-numbered/even-numbered connected code “0xAFAFD8D8”. Alternatively, the odd-numbered connected code “0xAFAF” and the even-numbered connected code “0xD8D8” are connected in the sequence of the even-numbered connected code followed by the odd-numbered connected code to generate an even-numbered/odd-numbered connected code “0xD8D8AFAF”.

The generated odd-numbered/even-numbered connected code “0xAFAFD8D8” and even-numbered/odd-numbered connected code “0xD8D8AFAF” are given to the same function as the function used in the byte calculating process. Specifically, both codes are divided by the same value 47(0x2F) to yield remainders “0x1B” and “0x27”. These remainders are connected together to yield a converted code “0x1B27” as a result of the digit calculating process.

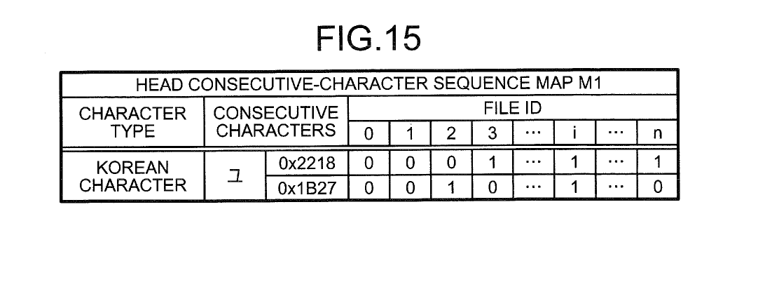

FIG. 15 is a schematic of an example of an entry, in the single-character map M1, of the converted codes acquired by the processes depicted in FIG. 14. For the Korean character “ [symbol] ”, a flag row is set respectively for the converted code “0x2118” resulting from the byte calculating process and for the converted code “0x1B27” resulting from the digit calculating process.

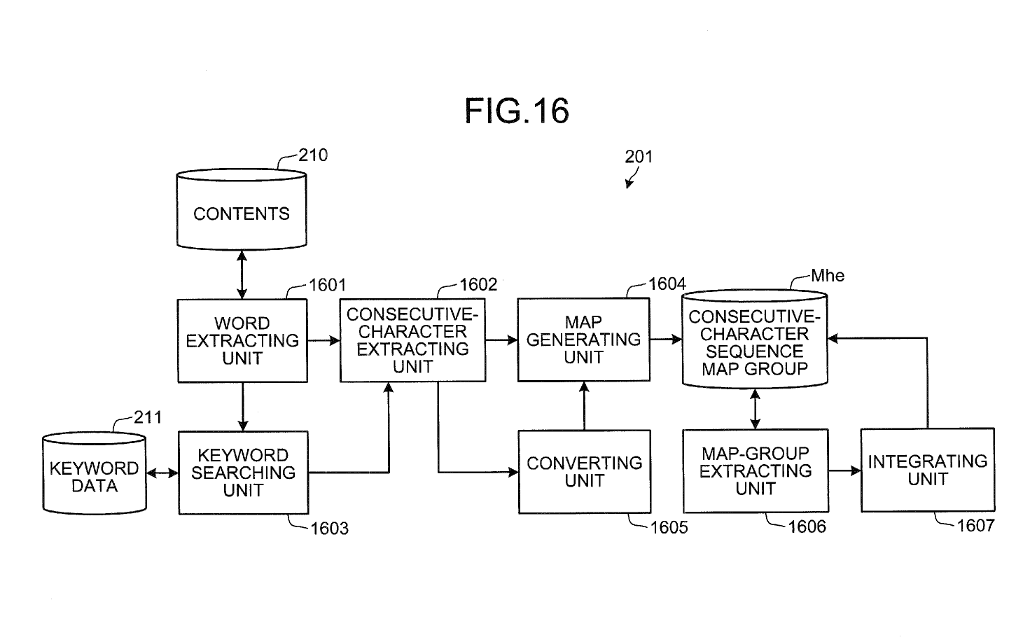

FIG. 16 is a block diagram of a second functional configuration of the map generating apparatus 201. A function of generating the consecutive-character sequence map group Mhe is described with reference to FIG. 16. As depicted in FIG. 16, the map generating apparatus 201 includes a word extracting unit 1601, a consecutive-character extracting unit 1602, a keyword searching unit 1603, a map generating unit 1604, a converting unit 1605, a map-group extracting unit 1606, and an integrating unit 1607. Respective functions of each unit (the word extracting unit 1601 to the integrating unit 1607) are implemented by the CPU 101 executing a program stored in such a memory area as the ROM 102, the RAM 103, and the HD 105 depicted in FIG. 1.

The word extracting unit 1601 has a function of extracting a word of which the number of characters is q (q≧2) from each of files making up the contents 210. Specifically, when a sentence in the file fi is written in English, for example, spaces exist between words, so that a word can be extracted by detecting a space. When a sentence in the file fi is written in Japanese, a word can be extracted by detecting the boundary between words by morphological analysis.

The consecutive-character extracting unit 1602 has a function of extracting consecutive characters from a word extracted by the word extracting unit 1601, the consecutive characters being consecutive from a character position s-th (1≦s≦q−r+1) from the head of the extracted word to a character position (s+r−1) determined by the number of characters r (r≦q). Specifically, for example, when extracting consecutive characters for which the number of characters r is 2, the consecutive-character extracting unit 1602 extracts consecutive characters “be”, “ea”, “au”, “ut”, “ti”, “if”, “fu”, and “ul” corresponding to the character position s from the head, as depicted in FIG. 9.

The consecutive-character extracting unit 1602 has a function of extracting consecutive characters from a word extracted by the word extracting unit 1601, the consecutive characters being consecutive from a character position t-th (1≦t≦q−r+1) from the end of the extracted word to a character position (t+r−1) determined by the number of characters r (r≦q). Specifically, for example, the consecutive-character extracting unit 1602 extracts consecutive characters “lu”, “uf”, “fi”, “it”, “tu”, “ua”, “ae”, and “eb” corresponding to the character position t from the end, as depicted in FIG. 10.

The keyword searching unit 1603 has a function of searching for a word matching a keyword in a character string included in a word extracted by the word extracting unit 1601. Specifically, for example, the keyword searching unit 1603 extracts a word matching a keyword registered in the keyword data 211, from among characters extracted by the word extracting unit 1601. For example, when a word extracted by the word extracting unit 1601 is a multi-phase word, such as “ [symbol] ” (international currency/monetary fund), the keyword searching unit 1603 further extracts words such as “ [symbol] ” (international), “ [symbol] ” (international currency), “ [symbol] ” (currency), and “ [symbol] ” (fund) that are included in the extracted word “ [symbol] ” (international currency/monetary fund). This enhances comprehensiveness in searching for a word matching a keyword in a consecutive-character sequence map. Details of this keyword search process will be described later.

The map generating unit 1604 has a function of generating a head consecutive-character sequence map Mhs, r for each character position s from the word head.

Specifically, for example, the map generating unit 1604 generates a head consecutive-character sequence map Mhs, r by the method depicted in FIG. 9. The map generating unit 1604 further has a function of generating an end consecutive-character sequence map Met, r for each character position t from the word end. Specifically, for example, the map generating unit 1604 generates an end consecutive-character sequence map Met, r by the method depicted in FIG. 10.

The converting unit 1605 has a function of converting a character code string for consecutive characters extracted by the consecutive character extracting unit 1602. This converting process is referred to as a common conversion process. Specifically, when extracted consecutive characters are an alphanumeric character string, the consecutive characters are converted into a determined code string of either a one-byte character code string or a two-byte character code string. For example, for a default for one-byte characters, when an alphanumeric character string of one-byte characters is read in, the alphanumeric character string is delivered directly to the map generating unit 1604. Conversely, when an alphanumeric character string of two-byte characters is read in, the alphanumeric character string is converted into a one-byte character code string of the alphanumeric character string. Thus, the character types of alphanumeric characters are unified to a common character type of either one-byte characters or two-byte characters (i.e., default setup character size). The number of consecutive characters of alphanumeric character strings is, therefore, reduced to half, enabling a reduction in the size of the consecutive-character sequence map group Mhe.

The converting unit 1605 further has a function of converting a code string for extracted consecutive characters into a voiced-consonant-free character code string when the extracted consecutive characters are a kana character string including a voiced consonant, semi-voiced consonant, or contracted sound. This converting process is referred to as voiced-consonant-free character process. For example, when kana consecutive characters “ [symbol] ” are read in, the kana consecutive characters are converted into a character code string for “ [symbol] ”. Likewise, when katakana consecutive characters “ [symbol] ” are read in, the katakana consecutive characters are converted into a character code string for “ [symbol] ”. This voiced-consonant-free process reduces the number of kana (and katakana) consecutive characters, and thus enables a reduction in the size of the consecutive-character sequence map group Mhe.

The converting unit 1605 also has a function of converting extracted consecutive characters into a character code string shorter than the original character code string for the consecutive characters. Specifically, the advantage of the JIS column/line code is utilized. For example, when consecutive characters are a kana/kanji character string, a column/line code string for the kana/kanji character string is converted into a line code string generated by connecting line codes for respective characters. For example, a code string for consecutive characters “ [symbol] ” is made up of a column/line code “2719” for a single character “ [symbol] ” and a column/line code “3278” for a single character “ [symbol] ”. This code string is converted into a code string generated by connecting the line codes for respective single characters. For example, in the case of “ [symbol] ”, the line code “19” for the single character “ [symbol] ” is connected to the line code “78” for the single character “ [symbol] ”. As a result, a connected code “1978” is generated as a new code for the consecutive characters “ [symbol] ”.

The types of kanji characters amount to 5,000 to 8,000 types. The size of a consecutive characters map for two kanji characters is the square of the size of the single-character map M1 for a single kanji character, that is, 5,000 to 8,000 times the size of the single-character map M1. The enormous size of the consecutive characters map makes stationing the consecutive characters map permanently on the cache memory difficult. For this reason, the consecutive-character sequence map group Mhe is made using codes connecting line codes, as described above. This consecutive-character sequence map group Mhe has a map size that accommodates 94 types×94 types=8836 types of kanji characters, which is a proper size.

When consecutive characters are a kana/kanji character string, a Korean character string, or a Chinese character string (kana/kanji character string, etc.), the converting unit 1605 converts the consecutive characters into a first converted code (converted code resulting from the byte calculating process) generated by connecting respective remainders that are acquired when two code strings generated from a character code string for the kana/kanji character string, etc. are given to a function of dividing the two code strings by a given code, and into a second converted code (converted code resulting from the digit calculating process) generated by connecting respective remainders that are acquired when two code strings generated from the character code string for the kana/kanji character string, etc. are given to the function of dividing the two code strings by the given code.

When consecutive characters are an alphanumeric character string or a kana character string (alphanumeric character string, etc.), the converting unit 1605 converts the consecutive characters into a first converted code (converted code resulting from the byte calculating process) generated by connecting respective remainders that are acquired when two code strings generated from a character code string for the alphanumeric character string, etc. are given to a function of dividing the two code strings by a given code, and into a second converted code (converted code resulting from the digit calculating process) generated by connecting respective remainders that are acquired when two code strings generated from the character code string for the alphanumeric character string, etc. are given to the function of dividing the two code strings by the given code. The contents of these conversion processes will be described hereinafter.

The map-group extracting unit 1606 has a function of extracting a consecutive-character sequence map group Mh for a character position of (s+kc)th (k denotes 0 or a positive integer) from the head consecutive-character sequence map group Mh generated by the generating unit 1604 when a given cyclic number c is set. Specifically, for example, when the number of characters r of consecutive characters is 2 and the cyclic number is 3, a group of head consecutive-character sequence maps Mh1, 2, Mh4, 2, Mh7, 2, . . . are extracted when the character position s is set to 1.

Likewise, when the character position s is set to 2, a group of head consecutive-character sequence maps Mh2, 2, Mh5, 2, Mh8, 2, . . . , Mh(2+3k), 2 are extracted. Likewise, when the character position s is set to 2, a group of head consecutive-character sequence maps Mh2, 2, Mh5, 2, Mh8, 2, . . . are extracted.

The map-group extracting unit 1606 has a function of extracting a consecutive-character sequence map group Mh for a character position of (t+kc)th (k denotes 0 or a positive integer) from the end consecutive-character sequence map group Me generated by the generating unit 1604 when a given cyclic number c is set. Specifically, for example, when the number of characters r of consecutive characters is 2 and the cyclic number is 3, a group of end consecutive-character sequence maps Me1, 2, Me4, 2, Me1, 2, . . . are extracted when the character position t is set to 1.

Likewise, when the character position t is set to 2, a group of end consecutive-character sequence maps Me2, 2, Me5, 2, Me8, 2, . . . , Me(2+3k), 2 are extracted. Likewise, when the character position t is set to 2, a group of end consecutive-character sequence maps Me2, 2, Me5, 2, Me8, 2, . . . are extracted.

The integrating unit 1607 integrates a map group extracted by the map group extracting unit 1601 to generate a single consecutive-character sequence map. Specifically, the integrating unit 1607 calculates the logical product of flags identified by the same consecutive characters and the same files in a consecutive-character sequence map group for the character position (s+kc) extracted by the map-group extracting unit 1606 to integrate the consecutive-character sequence map group for the character position(s+kc) into a single consecutive-character sequence map.

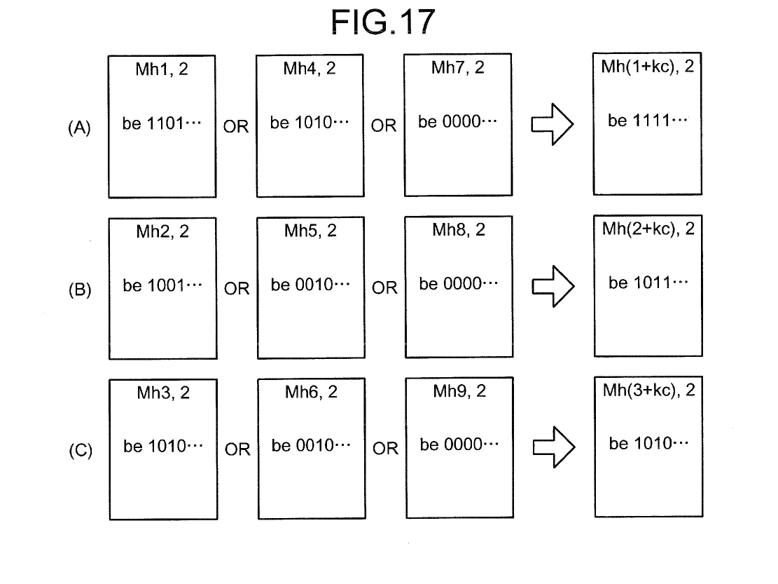

FIG. 17 is a schematic of an integrating process by the integrating unit 1607. In FIG. 17, the number of characters r of consecutive characters is 2 and the cyclic number is 3. As depicted in FIG. 17, an integrating process (A) of a map group involves integrating head consecutive-character sequence maps Mh1, 2, Mh4, 2, and Mh7, 2 that are extracted when the character position s is set to 1. In the integrating process (A), the logical product of flag rows for the same consecutive characters is calculated to generate an integrated head consecutive-character sequence map Mh(1+kc), 2.

An integrating process (B) of integrating a map group involves integrating head consecutive-character sequence maps Mh2, 2, Mh5, 2, and Mh8, 2 that are extracted when the character position s is set to 2. In the integrating process, the logical product of flag rows for the same consecutive characters is calculated to generate an integrated head consecutive-character sequence map Mh(2+kc), 2.

An integrating process (C) of integrating a map group involves integrating head consecutive-character sequence maps Mh3, 2, Mh6, 2, and Mh9, 2 that are extracted when the character position s is set to 3. In the integrating process, the logical product of flag rows for the same consecutive characters is calculated to generate an integrated head consecutive-character sequence map Mh(3+kc), 2.

In this manner, as depicted in FIG. 17, in the integrating processes (A) to (C), each of the map groups is integrated into a single head consecutive-character sequence map Mh(s+kc), r, which enables a reduction in map size. The integrating unit 1607 is thus able to reduce nine head consecutive-character sequence maps Mh1, 2 to Mh9, 2 to three maps Mh(1+kc), 2 to Mh(3+kc), 2 as depicted in FIG. 17. The integrating process above is performed in the same manner in generating an integrated end consecutive-character sequence map Met, r.

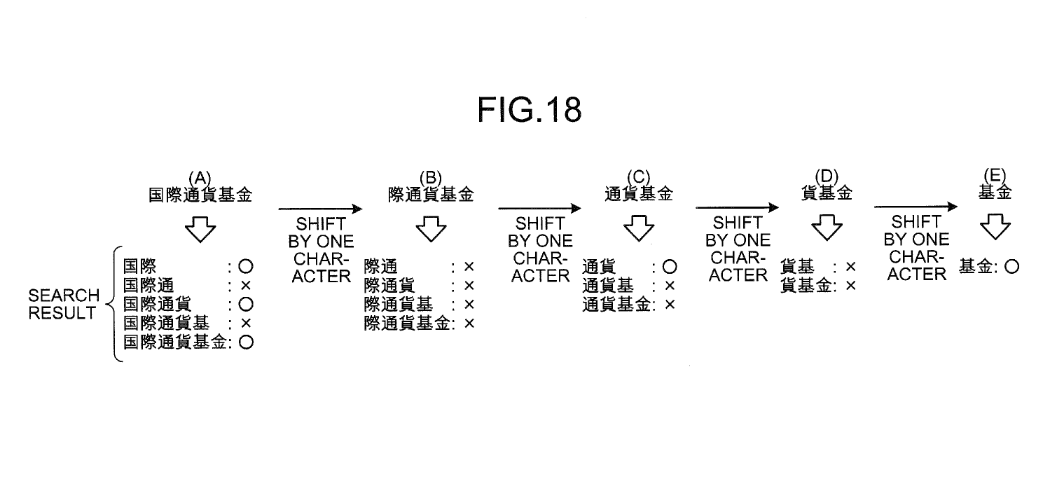

FIG. 18 is a schematic of a keyword search process by the keyword searching unit 1603 depicted in FIG. 16. In English, words are separated from each other via spaces. Consequently, forward-match search, reverse-match search, and full text search for complete matching can be performed easily, for example, in a search for “beautiful”. In contrast, Japanese words are not separated via spaces. Additionally, many Japanese words are made up of plural phrases (words), such as “ [symbol] ” made up of “ [symbol] ”, “ [symbol] ”, and “ [symbol] ”. As a result, if “ [symbol] ” is searched for using a keyword “ [symbol] ”, a flag row may not have been generated for the word “ [symbol] ”.

Consequently, for a word made up of plural phrases (words), each phrase (word) is extracted to improve comprehensiveness in word searching. In this process, when a word extracted by the word extracting unit 1601 is made up of plural phrases, a word matching a keyword is cut out from the extracted word as a word to be extracted by the consecutive-character extracting unit 1602. In FIG. 18, for example, the extracted word is “ [symbol] ”.

In section (A) of FIG. 18, the word “ [symbol] ” includes five sets of consecutive characters. Among the five sets of consecutive characters, consecutive characters matching a keyword in keyword search are three sets of consecutive characters including “ [symbol] ”, “ [symbol] ”, and “ [symbol] ”. The extracted word of “ [symbol] ” is shifted by one character to remove the head character “ [symbol] ”, thus becoming “ [symbol] ”.

In section (B) of FIG. 18, the word “ [symbol] ” resulting from character shifting includes four sets of consecutive characters. None of these four sets of consecutive characters, however, matches the keyword in keyword search. “ [symbol] ”, which is now a keyword search source, is shifted by one character to remove the head character “ [symbol] ”, thus becoming “ [symbol] ”.

In section (C) in FIG. 18, the word “ [symbol] ” includes three sets of consecutive characters. Among the three sets of consecutive characters, consecutive characters matching the keyword in keyword search is “ [symbol] ” only. “ [symbol] ”, which is now a keyword search source, is shifted by one character to remove the head character “ [symbol] ”, thus becoming “ [symbol] ”.

In section (D) of FIG. 18, the word “ [symbol] ” includes two sets of consecutive characters. None of these two sets of consecutive characters, however, matches the keyword in keyword search. “ [symbol] ”, which is now a keyword search source, is shifted by one character to remove the head character “ [symbol] ”, thus becoming “ [symbol] ”.

In section (E) of FIG. 18, the word “ [symbol] ” includes one set of consecutive characters. This consecutive characters matches the keyword in keyword search. In this manner, to the extracted word “ [symbol] ”, the consecutive characters “ [symbol] ”, “ [symbol] ”, “ [symbol] ”, and “ [symbol] ” each matching the keyword in keyword search in sections (A) to (E) are newly added as extracted words to make up a consecutive characters extraction source for the consecutive-character extracting unit 1602. Thus, comprehensiveness in search for a word matching the keyword on a consecutive-character sequence map improves.

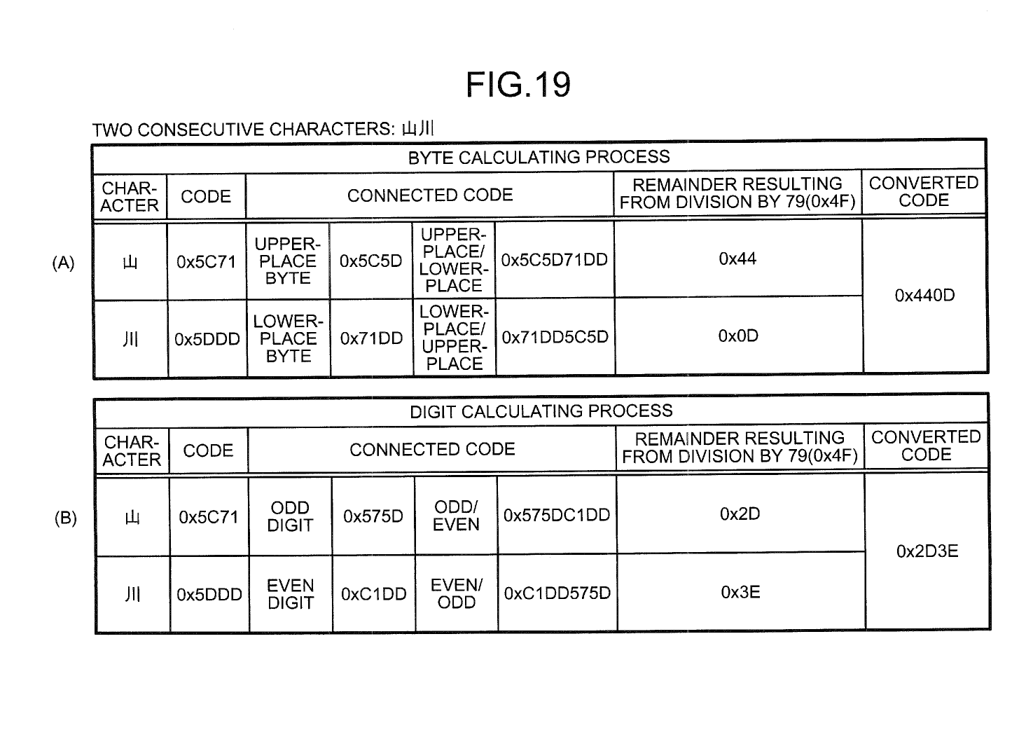

FIG. 19 is a schematic of a code converting process on a kana/kanji character string, etc., by the converting unit 1605 depicted in FIG. 16. FIG. 19 depicts a code converting process referred to as byte calculating process (A), and a code converting process referred to as digit calculating process (B). With reference to FIG. 19, the code converting process is described taking kanji consecutive characters “ [symbol] ” as an example.

In the byte calculating process (A), a character code “0x5C71” for “ [symbol] ” is separated into an upper-place byte “5C” and a lower-place byte “71”. Likewise, a character code “0x5DDD” for “ [symbol] ” is separated into an upper-place byte “5D” and a lower-place byte “DD”. Then, the upper-place bytes “5C” and “5D” of respective characters are connected together to generate an upper-place connected code “0x5C5D”. Likewise, the lower-place bytes “71” and “DD” of respective characters are connected together to generate a lower-place connected code “0x71DD”.

Then, the upper-place connected code “0x5C5D” and the lower-place connected code “0x71DD” are connected in the sequence of the upper-place connected code followed by the lower-place connected code to generate an upper-place/lower-place connected code “0x5C5D71DD”. Alternatively, the upper-place connected code “0x5C5D” and the lower-place connected code “0x71DD” are connected in the sequence of the lower-place connected code followed by the upper-place connected code to generate a lower-place/upper-place connected code “0x71DD5C5D”.

The generated upper-place/lower-place connected code “0x5C5D71DD” and lower-place/upper-place connected code “0x71DD5C5D” are given to the same function. Specifically, both codes are separated by the same value 79(0x4F) to yield remainders “0x44” and “0x0D”. These remainders are connected together to yield a converted code “0x440D” as a result of the byte calculating process.

In the digit calculating process (B), the character code “0x5C71” for “ [symbol] ” is separated according to digit position, including odd digit positions occupied by “5” and “7” and even digit positions occupied by “C” and “1”. In the same manner, the character code “0x5DDD” for “ [symbol] ” is separated according to odd digit positions occupied by “5” and “D” and even digit positions occupied by “D” and “D”. “57” and “5D” occupying the odd digit positions of the respective character codes are connected to generate an odd-numbered connected code “0x575D”. In the same manner, “C1” and “DD” occupying the even digit positions of respective character codes are connected to generate an even-numbered connected code “0xC1DD”.

Then, the odd-numbered connected code “0x575D” and the even-numbered connected code “0xC1DD” are connected in the sequence of the odd-numbered connected code followed by the even-numbered connected code to generate an odd-numbered/even-numbered connected code “0x575DC1DD”. Alternatively, the odd-numbered connected code “0x575D” and the even-numbered connected code “0xC1DD” are connected in the sequence of the even-numbered connected code followed by the odd-numbered connected code to generate an even-numbered/odd-numbered connected code “0xC1DD575D”.

The generated odd-numbered/even-numbered connected code “0x575DC1DD” and even-numbered/odd-numbered connected code “0xC1DD575D” are given to the same function. Specifically, both codes are divided by the same value 79(0x4F) to yield remainders “0x2D” and “0x3E”. These remainders are connected together to yield a converted code “0x2D3E” as a result of the digit calculating process.

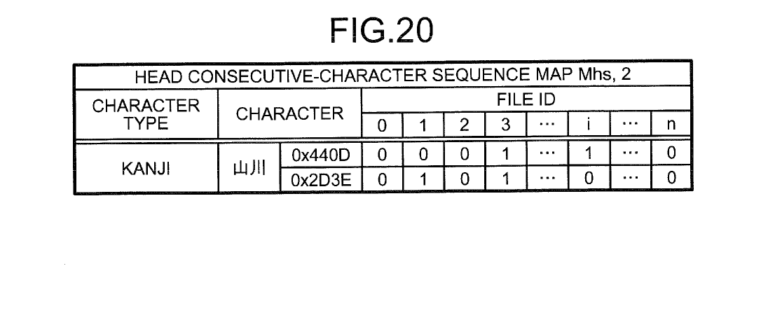

FIG. 20 is a schematic of an example of an entry of the converted codes acquired by the processes depicted in FIG. 19, in a head consecutive characters map Mhs, 2. For the consecutive characters “ [symbol] ”, a flag row is set respectively for the converted code “0x440D” resulting from the byte calculating process and for the converted code “0x2D3E” resulting from the digit calculating process.

Because code conversion is performed with the value of a combination of remainders, different characters may be represented by the same code. For this reason, two types of code conversion are performed to generate a flag row for each of the converted codes corresponding to one foreign character. When a search is conducted, logical product calculation (crossover processing) on the flag rows is performed, enabling kana/kanji character strings, etc. to be precisely narrowed down.

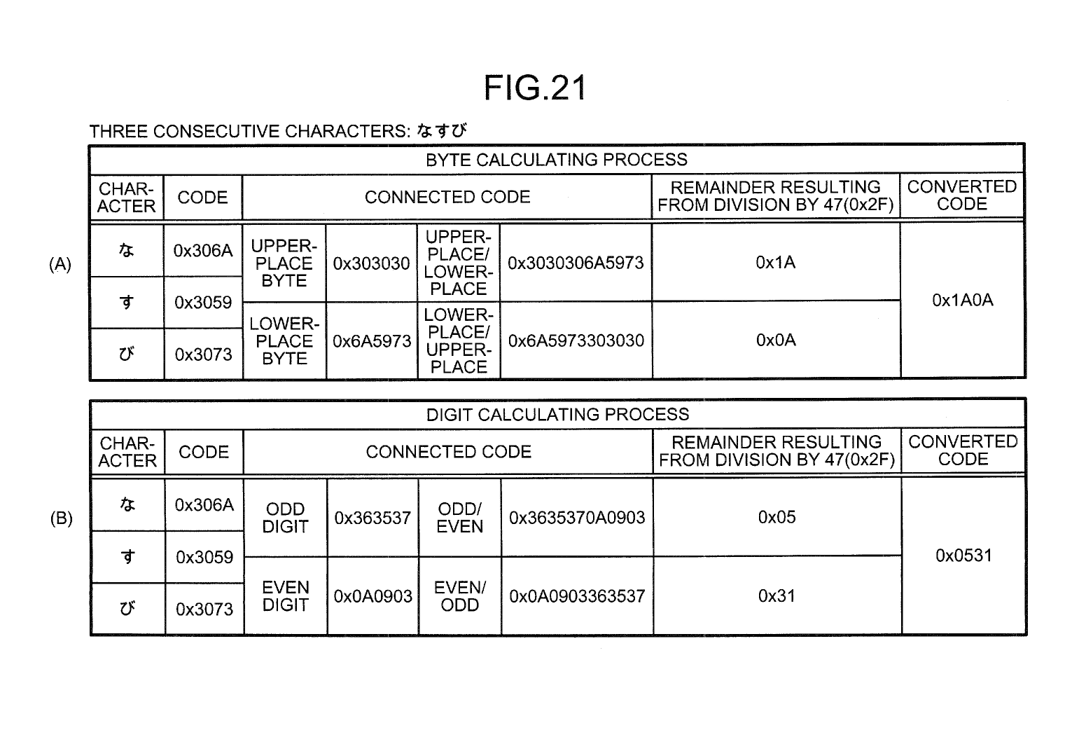

FIG. 21 is a schematic of a code converting process on an alphanumeric character string, etc., by the converting unit 1605 depicted in FIG. 16. FIG. 21 depicts a code converting process referred to as byte calculating process (A), and a code converting process referred to as digit calculating process (B). With reference to FIG. 21, the code converting process will be described taking a kana consecutive character string including three characters “ [symbol] ” as an example.

In the byte calculating process (A), a character code “0x306A” for “ [symbol] ” is separated into an upper-place byte “30” and a lower-place byte “6A”. Likewise, a character code “0x3059” for “ [symbol] ” is separated into an upper-place byte “30” and a lower-place byte “59”. Further a character code “0x3073” for “ [symbol] ” is separated into an upper-place byte “30” and a lower-place byte “73”.

Then, the upper-place bytes “30”, “30”, and “30” of respective characters are connected together to generate an upper-place connected code “0x303030”. Likewise, the lower-place bytes “6A”, “59”, and “73” of respective characters are connected together to generate a lower-place connected code “0x6A5973”.

Next, the upper-place connected code “0x303030” and the lower-place connected code “0x6A5973” are connected in the sequence of the upper-place connected code followed by the lower-place connected code to generate an upper-place/lower-place connected code “0x3030306A5973”. Alternatively, the upper-place connected code “0x303030” and the lower-place connected code “0x6A5973” are connected in the sequence of the lower-place connected code followed by the upper-place connected code to generate a lower-place/upper-place connected code “0x6A5973303030”.

The generated upper-place/lower-place connected code “0x3030306A5973” and lower-place/upper-place connected code “0x6A5973303030” are given to the same function. Specifically, both codes are divided by the same value 47(0x2F) to yield remainders “0x1A” and “0x0A”. These remainders are connected together to yield a converted code “0x1A0A” as a result of the byte calculating process.

In the digit calculating process (B), the character code “0x306A” for “ [symbol] ” is separated according to digit position, including odd digit positions occupied by “3” and “6” and even digit positions occupied by “0” and “A”. In the same manner, the character code “0x3059” for “ [symbol] ” is separated according to odd digit positions occupied by “3” and “5” and even digit positions occupied by “0” and “9”. Further, the character code “0x3073” for “ [symbol] ” is separated into odd digit positions occupied by “3” and “7” and even digit positions occupied by “0” and “3”.

“36”, “35”, and “37” occupying the odd digit positions of the respective character codes are connected to generate an odd-numbered connected code “0x363537”. In the same manner, “OA”, “09” and “03” occupying the even digit positions of the respective character codes are connected to generate an even-numbered connected code “0x0A0903”.

Then, the odd-numbered connected code “0x363537” and the even-numbered connected code “0x0A0903” are connected in the sequence of the odd-numbered connected code followed by the even-numbered connected code to generate an odd-numbered/even-numbered connected code “0x3635370A0903”. Alternatively, the odd-numbered connected code “0x363537” and the even-numbered connected code “0x0A0903” are connected in the sequence of the even-numbered connected code followed by the odd-numbered connected code to generate an even-numbered/odd-numbered connected code “0x0A09033563537”.

The generated odd-numbered/even-numbered connected code “0x3635370A0903” and even-numbered/odd-numbered connected code “0x0A0903363537” are given to the same function. Specifically, both codes are divided by the same value 47(0x2F) to yield remainders “0x05” and “0x31”. These remainders are connected together to yield a converted code “0x0531” as a result of the digit calculating process.

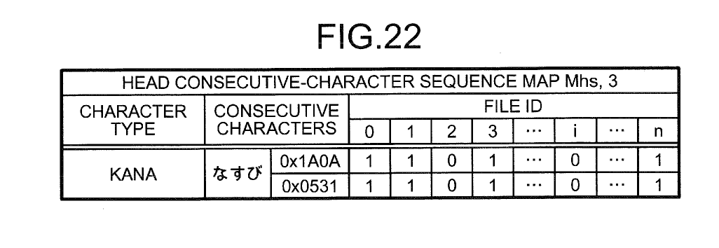

FIG. 22 is a schematic of an example of an entry of the converted codes acquired by the processes depicted in FIG. 21, in a head consecutive characters map Mhs, 3. For the consecutive characters “ [symbol] ”, a flag row is set respectively for the converted code “0x1A0A” resulting from the byte calculating process and for the converted code “0x0531” resulting from the digit calculating process.

Because code conversion is performed with the value of a combination of remainders, different characters may be represented by the same code. For this reason, two types of code conversion are performed to generate a flag row for each of the converted codes corresponding to one foreign character. When a search is conducted, logical product calculation (crossover processing) on the flag rows is performed to enable a precise narrowing down of foreign character strings, etc.

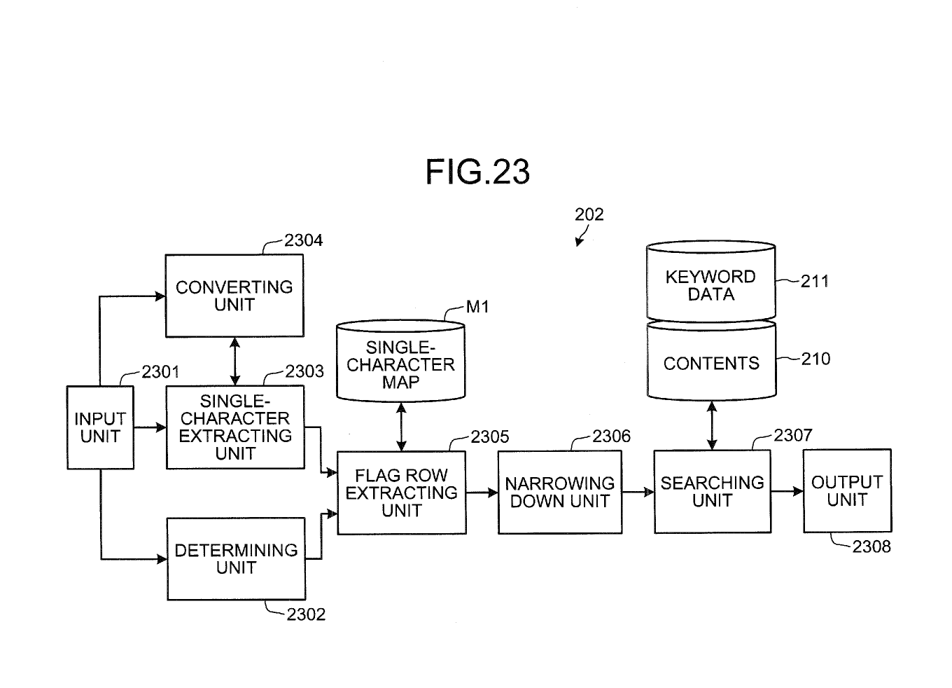

FIG. 23 is a block diagram of a first functional configuration of the information searching apparatus 202. A function of narrowing down files using the single-character map M1 before performing a search and then performing the search is described with reference to FIG. 23. As depicted in FIG. 23, the information searching apparatus 202 includes an input unit 2301, a determining unit 2302, a single-character extracting unit 2303, a converting unit 2304, a flag row extracting unit 2305, a narrowing down unit 2306, a searching unit 2307, and an output unit 2308. Functions of each unit (the input unit 2301 to the output unit 2308) are implemented by the CPU 101 executing a program stored in a memory area such as the ROM 102, the RAM 103, and the HD 105 depicted in FIG. 1 or through the I/F 109.

The input unit 2301 has a function of receiving input of a search character string and a search condition. The search condition includes a forward-match search, a reverse-match search, a complete-match search, and a partial matching search. When the single-character map M1 is used, files are narrowed down through a partial matching search.

The determining unit 2302 has a function of determining whether a search condition is a partial matching search. When the search condition is a partial matching search, flag row extraction by the flag row extracting unit 2305 is performed. When the search condition is not a partial matching search, the search condition is any one of a forward-match search, a reverse-match search, and a complete-match search.

The single-character extracting unit 2303 has a function of sequentially extracting characters one by one with the head first from a search character string. For example, for a search character string “ [symbol] ”, the single-character extracting unit 2303 extracts “ [symbol] ”, “ [symbol] ”, “ [symbol] ”, and “ [symbol] ” as single search-characters.

The flag row extracting unit 2305 has a function of extracting a flag row for a single search-character from an entry of the single search-character on the single-character map M1 when the determining unit 2302 determines a search condition is for a partial matching search. When single search-characters are “ [symbol] ”, “ [symbol] ”, “ [symbol] ”, and “ [symbol] ”, the flag row extracting unit 2305 extracts the flag row for “ [symbol] ”, “ [symbol] ”, “ [symbol] ”, and “ [symbol] ”, respectively.

The converting unit 2304 has a function such that when a search character string includes a foreign character other than a modern Latin character, the converting unit 2304 converts the foreign character into a first converted code generated by connecting respective remainders that are acquired when two code strings generated from a character code for the foreign character are given to a function of dividing the two code strings by a given code, and into a second converted code generated by connecting respective remainders that are acquired when two code strings generated from the character code string for the foreign character are given to the function of dividing the two code strings by the given code.

Specifically, for example, the converting unit 2304 executes the byte calculating process and the digit calculating process executed by the foreign character converting unit 1303 depicted in FIG. 13. Consequently, from the code for the foreign character, the code converted by the byte calculating process and the code converted by the digit calculating process are generated, as depicted in FIG. 14. In this case, the flag row extracting unit 2305 extracts a flag row for the code converted by the byte calculating process and a flag row for the code converted by the digit calculating process, from the single-character map M1.

The narrowing down unit 2306 has a function of referring the single-character map M1 and narrowing down files inclusive of all of the single characters extracted by the single-character extracting unit 2303. Specifically, to narrow down files to those that include all of the single characters extracted by the single-character extracting unit 2303, the narrowing down unit 2306 calculates the logical product of flag rows extracted by the flag row extracting unit 2305 for the respective single characters.

When a single character is a foreign character, because two types of converted codes are present for the single character, logical product calculation on flag rows for two converted codes for the single character is performed before performing logical product calculation on a flag row for the single character and a flag row for another single character. The result of logical product calculation on the flag rows for two converted codes is equivalent to the flag row for the foreign character. For the Korean character depicted in FIG. 15, therefore, the Korean character is present in the file fi.

The searching unit 2307 has a function of searching for a character string matching or related to a search character string in a file narrowed down by the narrowing down unit 2306. The output unit 2308 has a function of outputting a search result obtained by the searching unit 2307. Specifically, for example, the output unit 2308 displays a position matching a keyword or full text as a search result on a display. The form of output includes transmission to an external apparatus, printout, vocal reading, and saving in an internal memory area, in addition to display on the display.

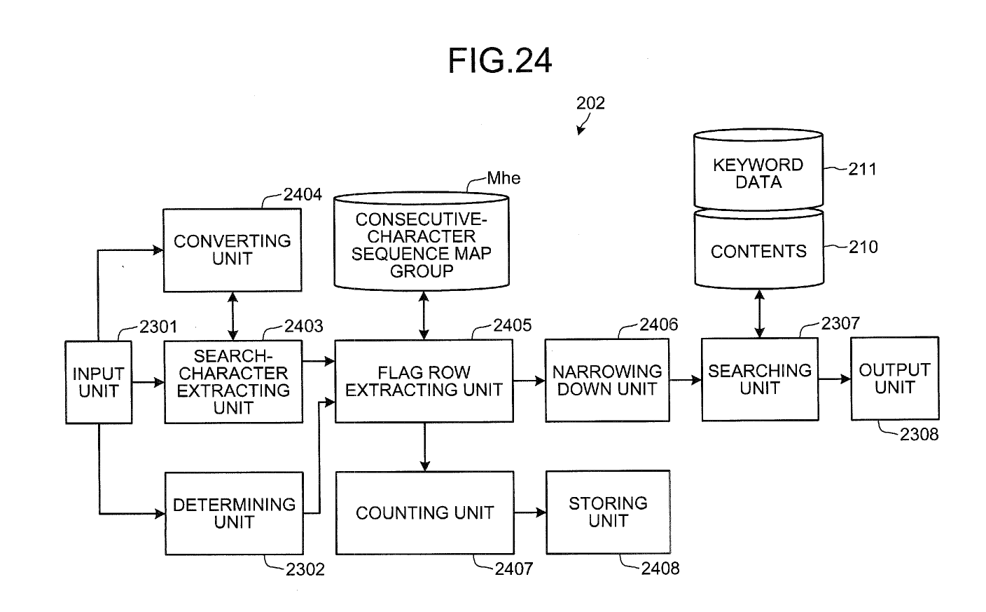

FIG. 24 is a block diagram of a second functional configuration of the information searching apparatus 202. A function of narrowing down files using the consecutive-character sequence map group Mhe before performing a search and then performing the search is described with reference to FIG. 24. Functional units identical to those described in FIG. 23 are denoted by identical reference numerals, and are omitted in further description.

As depicted in FIG. 24, the information searching apparatus 202 includes the input unit 2301, the determining unit 2302, a search-character extracting unit 2403, a converting unit 2404, a flag row extracting unit 2405, a narrowing down unit 2406, the searching unit 2307, the output unit 2308, a counting unit 2407, and a storing unit 2408. Respective functions of each unit (the input unit 2301 to the output unit 2308) are implemented by the CPU 101 executing a program stored in a memory area such as the ROM 102, the RAM 103, and the HD 105 depicted in FIG. 1 or through the I/F 109.

The search-character extracting unit 2403 has a function of extracting consecutive characters to be search for. The consecutive characters are extracted from the search character string, from a character position w-th (1≦w≦q−r+1) from the head of a search character string to a character position (w+r−1) determined by the number of characters r, when a search condition is a forward-match search. For example, when the search character string “beautiful” is input and the number of characters r is set to 2, the search-character extracting unit 2403 extracts consecutive characters “be”, “ea”, “au”, “ut”, “ti”, “if”, “fu”, and “ul” from w-th from the head.

The search-character extracting unit 2403 further has a function of extracting consecutive characters to be search for by extracting from the search character string, from a character position x-th (1≦x≦q−r+1) from the end of a search character string to a character position (x+r−1) determined by the number of characters r, when a search condition is reverse-match search. For example, when the search character string “beautiful” is input and the number of characters r is set to 2, the search-character extracting unit 2403 extracts consecutive characters “lu”, “uf”, “fi”, “it”, “tu”, “ua”, “ae”, and “eb” from x-th from the end. For a complete-match search, the search-character extracting unit 2403 extracts consecutive characters “be”, “ea”, “au”, “ut”, “ti”, “if”, “fu”, and “ul” from w-th from the head and consecutive characters “lu”, “uf”, “fi”, “it”, “tu”, “ua”, “ae”, and “eb” from x-th from the end.

The converting unit 2404 converts a character code string for a search character string, following the conversion rule of the converting unit 1605 depicted in FIG. 16. Specifically, when a search character string is an alphanumeric character string, the search character string is converted into a determined code string of either a one-byte character code string or a two-byte character code string. For example, for default for one-byte character, when an alphanumeric character string of one-byte characters is read in, the alphanumeric character string is delivered directly to the flag row extracting unit 2405. Conversely, when an alphanumeric character string of two-byte characters is read in, the alphanumeric character string is converted into a one-byte character code string of the alphanumeric character string.

When a search character string is a kana character string including a voiced consonant, semi-voiced consonant, or contracted sound, the converting unit 2404 converts the search character string into a voiced-consonant-free code string. For example, when kana consecutive characters “ [symbol] ” are read in, the kana consecutive characters are converted into a character code string for “ [symbol] ”. Likewise, when katakana consecutive characters “ [symbol] ” are read in, the katakana consecutive characters are converted into a character code string for “ [symbol] ”.

When a search character string is a kana/kanji character string, a column/line code string for the kana/kanji character string is converted into a line code string generated by connecting line codes for respective characters. For example, a code string for a search character string “ [symbol] ” is made up of the column/line code “2719” for the single character “ [symbol] ” and the column/line code “3278” for the single character “ [symbol] ”. This code string is converted into a code string generated by connecting the line codes for respective single characters. For example, in the case of “ [symbol] ”, the line code “19” for the single character “ [symbol] ” is connected to the line code “78” for the single character “ [symbol] ”. As a result, the connected code “1978” is generated as a new code for the consecutive characters “ [symbol] ”.

When consecutive characters is a kana/kanji character string, a Korean character string, or a Chinese character string (kana/kanji character string, etc.), the converting unit 2404 converts the consecutive characters into a converted code by the byte calculating process and into a converted code by the digit calculating process, as depicted in FIG. 19. Likewise, when consecutive characters is an alphanumeric character string or a kana character string (alphanumeric character string, etc.), the converting unit 2404 converts the consecutive characters into a code converted by the byte calculating process and into a code converted by the digit calculating process, as depicted in FIG. 21.

The flag row extracting unit 2405 has a function of extracting flag rows in entries of the same consecutive characters at the same character position from a corresponding consecutive-character sequence map group. Specifically, for consecutive characters starting from a character position w-th from the head, a flag row in an entry of the same consecutive characters on a head consecutive-character sequence map Mhs, r (s=w) is extracted. Likewise, for consecutive characters starting from a character position x-th from the end, a flag row in an entry of the same consecutive characters on an end consecutive-character sequence map Met, r (t=x) is extracted.

The narrowing down unit 2406 has a function of narrowing down files to those including a search character string by calculating the logical product of flag rows extracted by the flag row extracting unit 2405.

Specifically, for a forward-match search, the narrowing down unit 2406 calculates the logical product of flag rows for consecutive characters “be”, “ea”, “au”, “ut”, “ti”, “if”, “fu”, and “ul” from s-th from the head, as depicted in FIG. 11. A file having a flag value of “1” as a result of this logical product calculation is a file that includes a word having a character string read from its head as “beautiful”.

For a reverse-match search, the narrowing down unit 2406 calculates the logical product of flag rows for consecutive characters “lu”, “uf”, “fi”, “it”, “tu”, “ua”, “ae”, and “eb” from t-th from the end. A file having a flag value of “1” as a result of this logical product calculation is a file that includes a word having a character string read from its end as “lufituaeb”.

When performing file narrowing down for a complete-match search, the narrowing down unit 2406 further calculates the logical product of a result of the logical product calculation depicted in FIG. 11 and a result of the logical product calculation depicted in FIG. 12. A file having a flag value of “1” resulting from this calculation, is a file that includes not only a word having a character string read from its head as “beautiful” but also a word having a character string read from its end as “lufituaeb”.

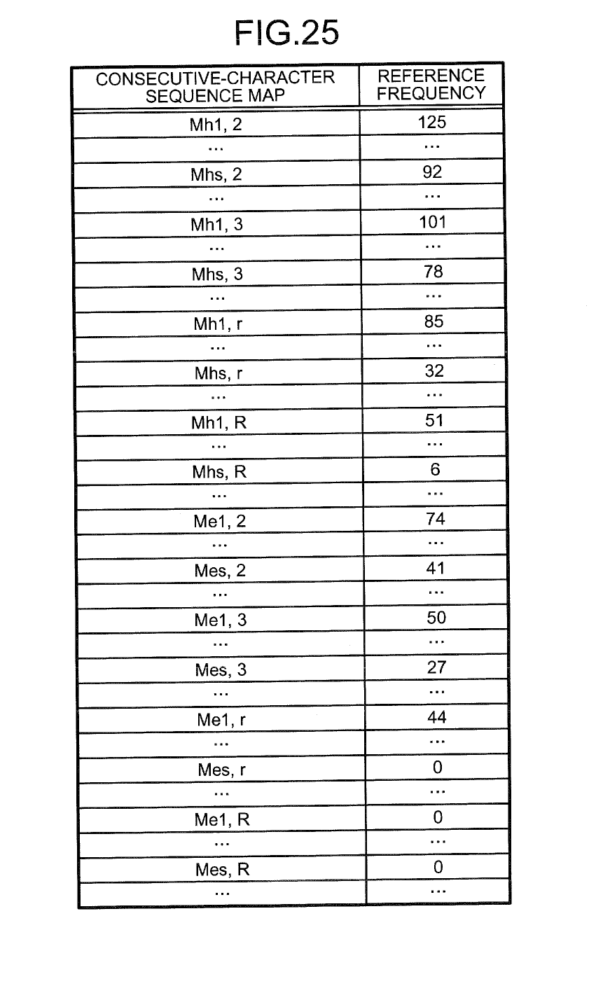

The counting unit 2407 has a function of counting the reference frequency of a consecutive-character sequence map. FIG. 25 is a schematic of a result of counting a reference frequency for each consecutive-character sequence map. As depicted in FIG. 25, 1 is added to a reference frequency each time a map is referenced. For example, when consecutive characters “be”, “ea”, “au”, “ut”, “ti”, “if”, “fu”, and “ul” from s-th from the head are given, the flag row extracting unit 2405 adds 1 to each of the reference frequencies of head consecutive-character sequence maps Mh1, 2 to Mh8, 2 in which respective consecutive characters are present.

The storing unit 2408 has a function of storing some consecutive-character sequence maps on the cache memory, based on a reference frequency, before the start of a search process. The map storage may be performed based on whether a reference frequency is at least equal to a given reference frequency, in which case consecutive-character sequence maps Mhe of which the reference frequencies range from the top to x-th in higher rank are written to the cache. In this manner, a map accessed frequently is written to the cache memory with preference to achieve high-speed processing.

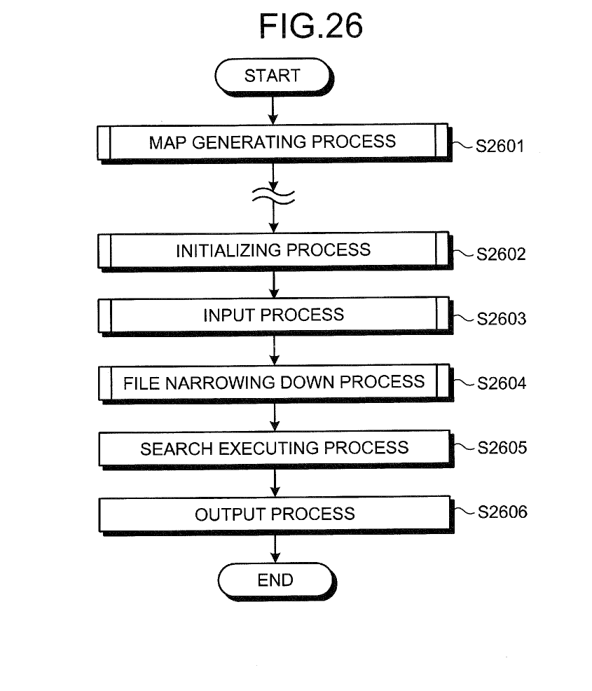

FIG. 26 is a flowchart of an overall procedure by the search system 200. As depicted in FIG. 26, the map generating apparatus 201 executes a map generating process (step S2601). Subsequently, an initializing process (step S2602), an input process (step S2603), a file narrowing down process (step S2604), a search executing process (step S2605), and an output process (step S2606) are executed successively.

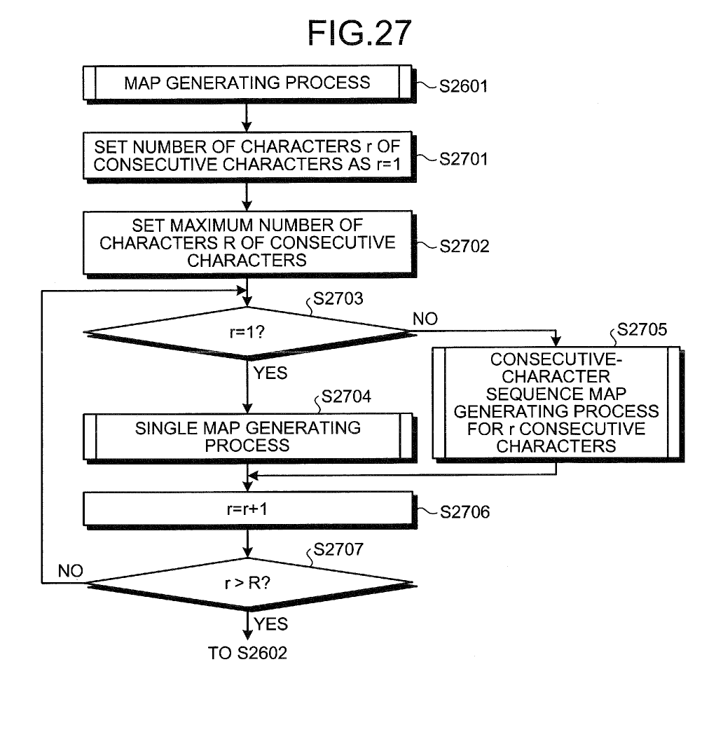

FIG. 27 is a flowchart of the map generating process (step S2601). First, the number of characters r of consecutive characters is set to 1 (step S2701), and the maximum number of characters R of consecutive characters is set (step S2702). Hereinafter, consecutive characters of which the number of characters is r is referred to as “r consecutive characters”. Whether the number of characters r=1 is satisfied is determined (step S2703). When the number of characters r=1 is satisfied (step S2703: YES), a single-character map M1 generating process is executed (step S2704), after which the procedure flow proceeds to step S2706.

When the number of characters r=1 is not satisfied (step S2703: NO), a consecutive-character sequence map generating process for r consecutive characters is executed (step S2705), after which the procedure flow proceeds to step S2706. At step S2706, the number of characters r of the consecutive characters is increased by 1 (step S2706), which is followed by a determination of whether r>R is satisfied (step S2707). When r>R is not satisfied (step S2707: NO), the procedure flow returns to step S2703. When r>R is satisfied (step S2707: YES), the procedure flow proceeds to the initializing process of step S2602.

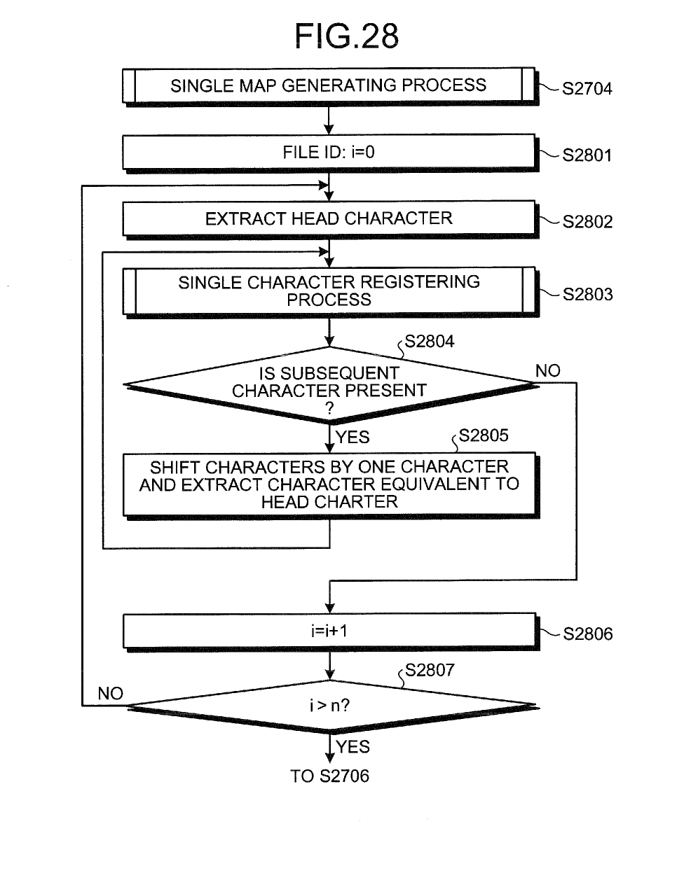

FIG. 28 is a flowchart of the single-character map generating process (step S2704). First, the file ID i is set to 0 (step S2801), and the head character is extracted from a file fi (step S2802). A single character registering process is then executed (step S2803). Whether a character subsequent to the head character is present in the file fi is determined (step S2804). When a subsequent character is present (step S2804: YES), characters are shifted by one character and a character equivalent to the head character after the shift is extracted (step S2805), after which the procedure flow returns to step S2803.

When a subsequent character is not present (step S2804: NO), the file ID i is increased by 1 (step S2806), and whether i>n is satisfied is determined (step S2807). When i>n is not satisfied (step S2807: NO), the procedure flow returns to step S2802. When i>n is satisfied (step S2807: YES), the procedure flow proceeds to step S2706.

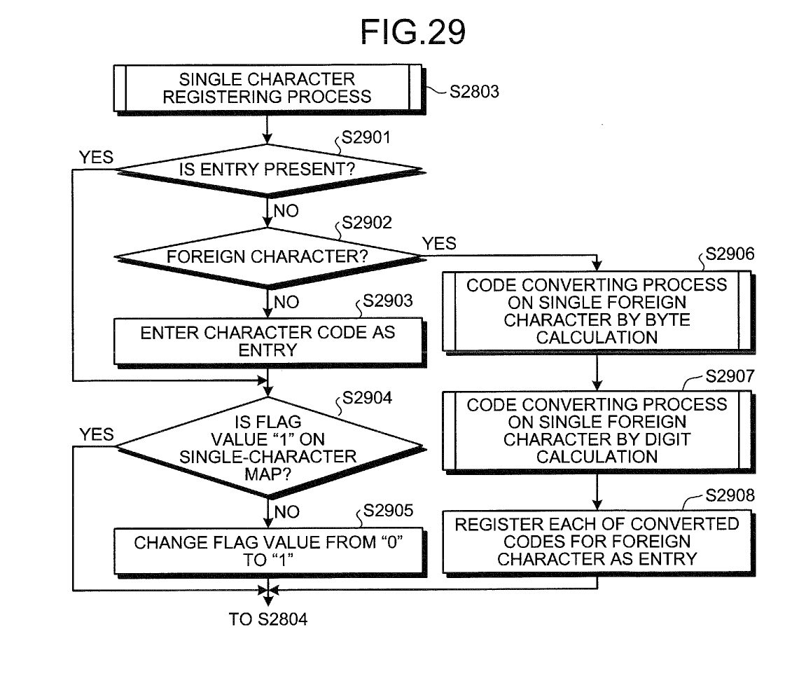

FIG. 29 is a flowchart of the single character registering process (step S2803). First, whether an entry of an extracted single character is present in the single-character map M1 is determined (step S2901). When the entry is present (step S2901: YES), the procedure flow proceeds to step S2904. When the entry is not present (step S2901: NO), whether the single character is a foreign character is determined (step S2902).

When the single character is not a foreign character (step S2902: NO), a character code for the character is entered as an entry (step S2903). Subsequently, whether a flag for the file ID i is “1” on the single-character map M1 is determined (step S2904). When the flag is “0” (step S2904: NO), the flag is changed in value from “0” to “1” (step S2905), after which the procedure flow proceeds to step S2804. When the flag is “1” (step S2904: YES), the procedure flow proceeds to step S2804.

When the single character is determined to be a foreign character at step S2902 (step S2902: YES), the foreign character converting unit 1303 executes a code converting process on the single foreign character by byte calculation (step S2906) and a code converting process on the single foreign character by the digit calculation (step S2907). Each of the converted codes for the foreign character is entered as an entry of the foreign character (step S2908), and the procedure flow proceeds to step S2804.

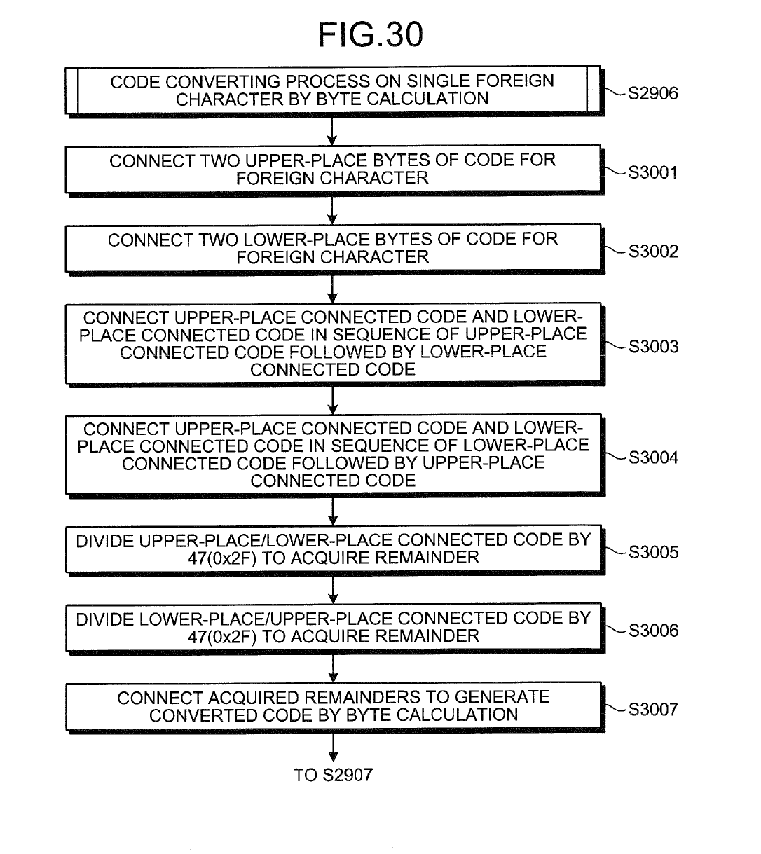

FIG. 30 is a flowchart of the code converting process on a single foreign character by byte calculation (step S2906). As depicted in FIG. 14, two upper-place bytes of a code for a foreign character are connected into an upper-place connected code (step S3001).

Two lower-place bytes of the code for the foreign character are connected into a lower-place connected code (step S3002). The upper-place connected code and the lower-place connected code are connected in the sequence of the upper-place connected code followed by the lower-place connected code to generate an upper-place/lower-place connected code (step S3003). Alternatively, the upper-place connected code and the lower-place connected code are connected in the sequence of the lower-place connected code followed by the upper-place connected code to generate a lower-place/upper-place connected code (step S3004).

The upper-place/lower-place connected code is then divided by 47(0x2F) to acquire a remainder (step S3005). The lower-place/upper-place connected code is also divided by 47 (0x2F) to acquire a remainder (step S3006). Subsequently, the acquired remainders are connected to generate a converted code by byte calculation (step S3007), after which the procedure flow proceeds to step S2907.

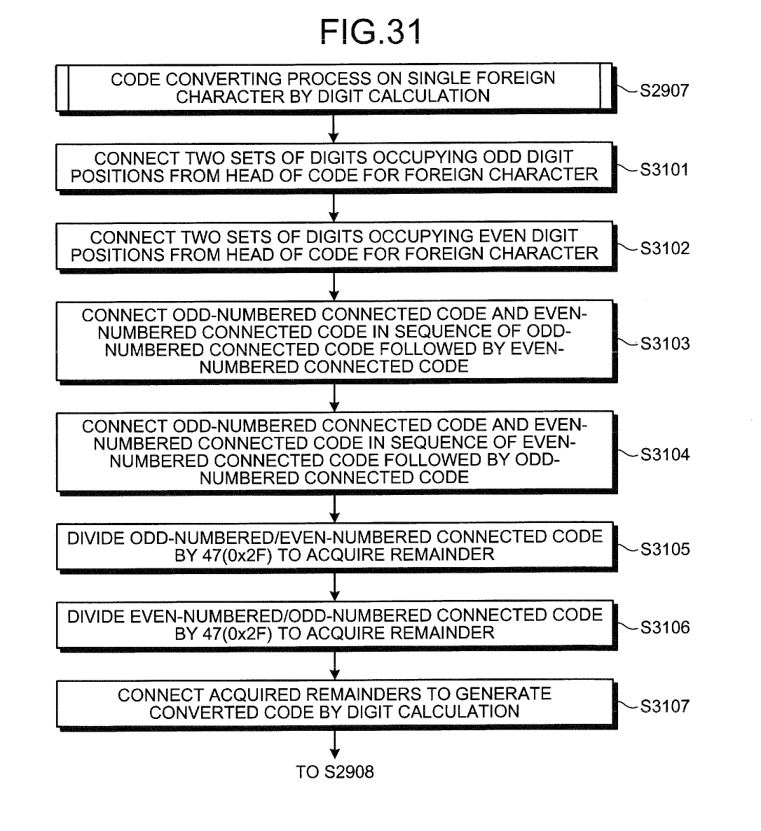

FIG. 31 is a flowchart of the code converting process on a single foreign character by digit calculation (step S2907). As depicted in FIG. 14, two sets of digits occupying odd digit positions from the head of a code for a foreign character are connected into an odd-numbered connected code (step S3101). Two sets of digits occupying even digit positions from the head of the code for the foreign character are connected into an even-numbered connected code (step S3102).

Then, the odd-numbered connected code and the even-numbered connected code are connected in the sequence of the odd-numbered connected code followed by the even-numbered connected code to generate an odd-numbered/even-numbered connected code (step S3103). Alternatively, the odd-numbered connected code and the even-numbered connected code are connected in the sequence of the even-numbered connected code followed by the odd-numbered connected code to generate an even-numbered/odd-numbered connected code (step S3104).

The odd-numbered/even-numbered connected code is then divided by 47(0x2F) to acquire a remainder (step S3105). The even-numbered/odd-numbered connected code is also divided by 47(0x2F) to acquire a remainder (step S3106). Subsequently, the acquired remainders are connected to generate a converted code by digit calculation (step S3107), after which the procedure flow proceeds to step S2908.

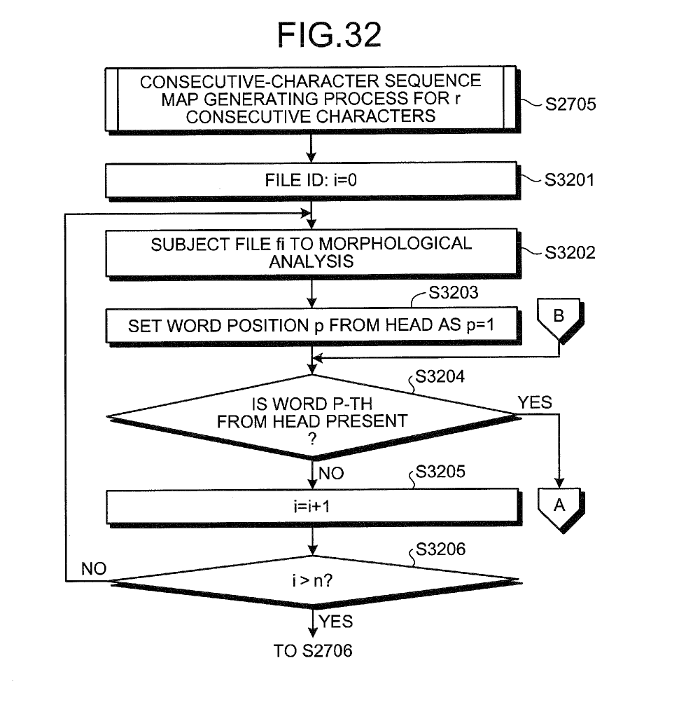

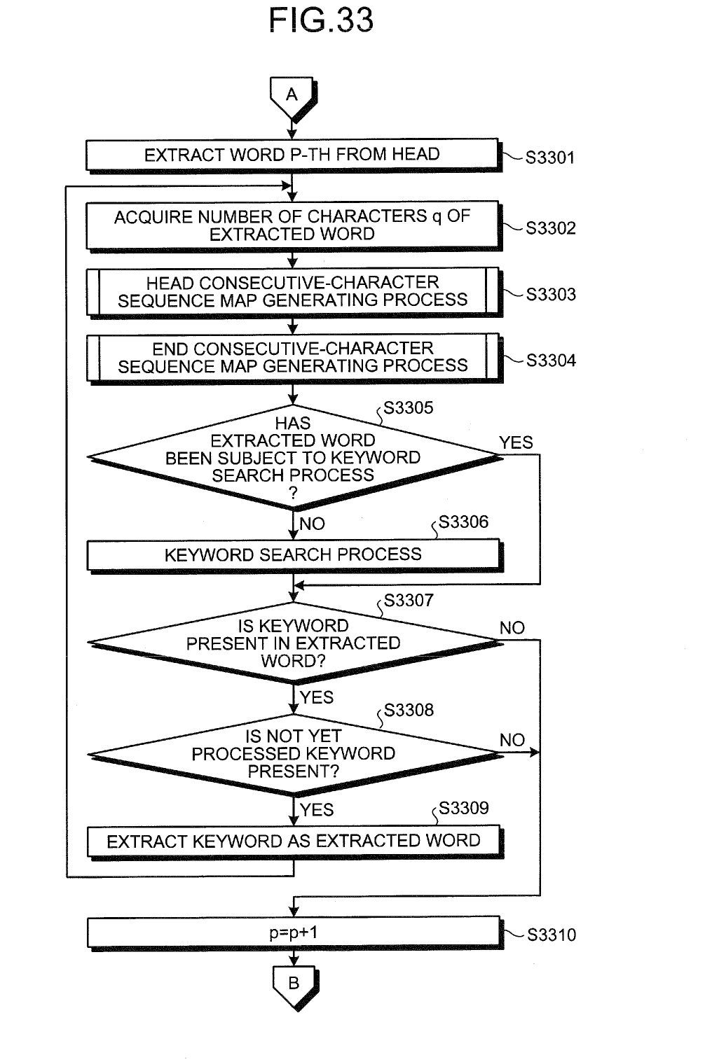

FIGS. 32 and 33 are flowcharts of the consecutive-character sequence map generating process for r consecutive characters (step S2705). As depicted in FIG. 32, the file ID i is set to “0” (step S3201), and the file fi is subjected to morphological analysis (step S3202). A word position p from the head is set to 1 (step S3203), and whether a word p-th from the head is present is determined (step S3204).

When a word p-th from the head is not present (step S3204: NO), the file ID i is increased by 1 becoming a file ID i for the next file fi (step S3205), and whether i>n is satisfied is determined (step S3206). When i>n is not satisfied (step S3206: NO), the procedure flow returns to step S3202. When i>n is satisfied (step S3206: YES), the procedure flow proceeds to step S2706.

When a word p-th from the head is present at step S3204 (step S3204: YES), the procedure flow proceeds to step S3301 of FIG. 33. At step S3301, the word p-th from the head is extracted from the file fi. Then, the number of characters q of the extracted word is acquired (step S3302), and a head consecutive-character sequence map generating process (step S3303) and an end consecutive-character sequence map generating process (step S3304) are executed by the consecutive-character extracting unit 1602 and the map generating unit 1604. Then, whether the extracted word has been subject to a keyword search process by the keyword searching unit 1603 is determined (step S3305).

When the extracted word has not been subject to a keyword search process (step S3305: NO), the keyword search process is executed (step S3306), after which the procedure flow proceeds to step S3307. When the extracted word has been subject to the keyword search process (step S3305: YES), the procedure flow proceeds directly to step S3307. At step S3307, whether a keyword is present in the extracted word is determined in the manner depicted in FIG. 18 (step S3307). When the keyword is not present (step S3307: NO), the procedure flow proceeds to step S3310.

When the keyword is present (step S3307: YES), whether a keyword that has not yet been processed is present is determined (step S3308). When a keyword that has not yet been processed is not present (step S3308: NO), the procedure flow proceeds to step S3310. When a keyword that has not yet been processed is present (step S3308: YES), the keyword is extracted as an extracted word (step S3309), after which the procedure flow returns to step S3302. At step S3310, the word position p is increased by 1, and the procedure flow proceeds to step S3204.

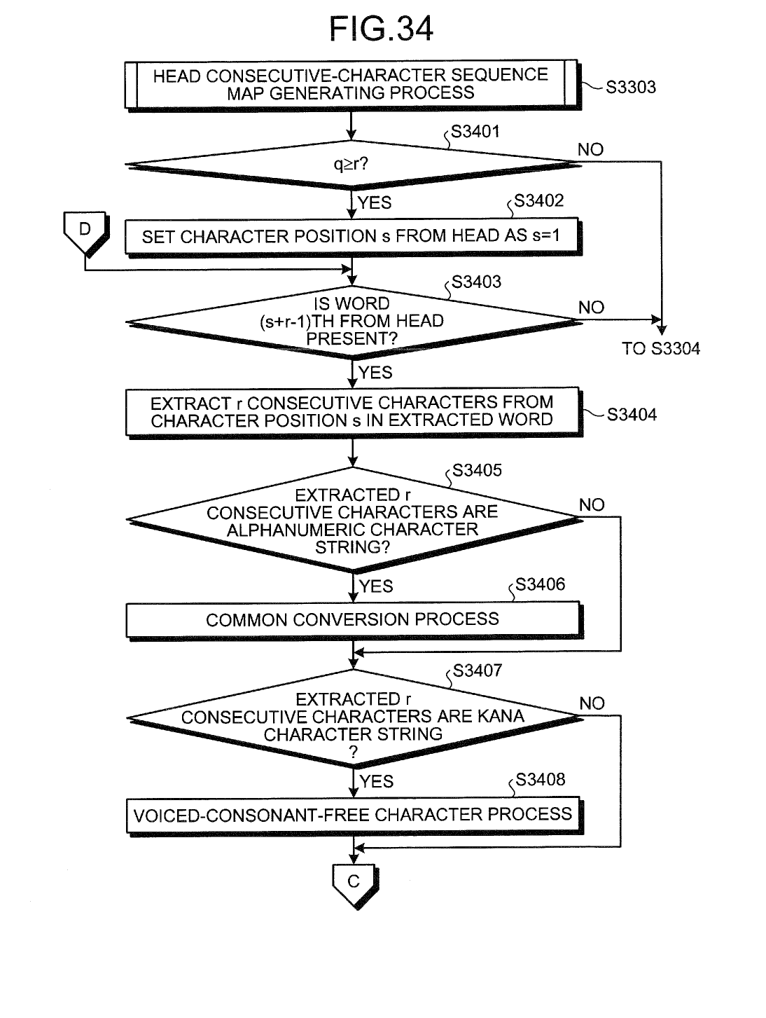

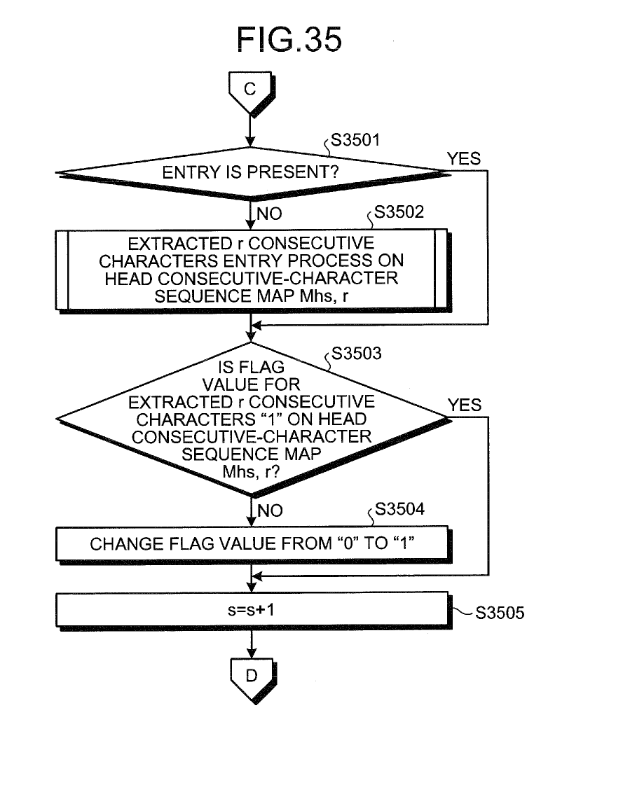

FIGS. 34 and 35 are flowcharts of the head consecutive-character sequence map generating process (step S3303). As depicted in FIG. 34, whether the number of characters q of an extracted word satisfies q≧r is determined (step S3401). When q≧r is not satisfied (step S3401: NO), the extracted word is equivalent to a single character or consecutive characters already entered on a map, so that the procedure flow proceeds to the end consecutive-character sequence map generating process (step S3304).

When q≧r is satisfied (step S3401: YES), a character position s from the head of the extracted word is set to 1 (step S3402), and whether a character (s+r−1)th from the head is present in the extracted word is determined (step S3403). When the character (s+r−1)th from the head is not present (step S3403: NO), no consecutive characters can be extracted from the extracted word, and the procedure flow proceeds to the end consecutive-character sequence map generating process (step S3304).

When the character (s+r−1)th from the head is present (step S3403: YES), r consecutive characters from the character position s are extracted from the extracted word (step S3404). Then, whether the extracted r consecutive characters are an alphanumeric character string is determined (step S3405). When the r consecutive characters are not an alphanumeric character string (step S3405: NO), the procedure flow proceeds to step S3407.

When the r consecutive characters are an alphanumeric character string (step S3405: YES), a common conversion process is executed by the converting unit 1605 (step S3406). Subsequently, whether the extracted r consecutive characters are a kana character string is determined (step S3407). When the r consecutive characters are not a kana character string (step S3407: NO), the procedure flow proceeds to step S3501 of FIG. 35. When the r consecutive characters are a kana character string (step S3407: YES), a voiced-consonant-free character process is executed by the converting unit 1605 (step S3408), after which the procedure flow proceeds to step S3501 of FIG. 35.

As depicted in FIG. 35, whether an entry of the extracted r consecutive characters is present in a head consecutive-character sequence map Mhs, r is determined (step S3501). When an entry is present already (step S3501: YES), the procedure flow proceeds to step S3503. When an entry is not present (step S3501: NO), an extracted r consecutive characters entry process on the head consecutive-character sequence map Mhs, r is executed (step S3502), after which the procedure flow proceeds to step S3503.

Then, whether a flag value for the file fi in the entry of the extracted r consecutive characters is “1” on the head consecutive-character sequence map Mhs, r is determined (step S3503). When the flag value is “1” (step S3503: YES), the procedure flow proceeds to step S3505. When the flag value is “0” (step S3503: NO), the flag value is changed from “0” to “1” (step S3504), and the character position s from the head is increased by 1 (step S3505), after which the procedure flow proceeds to step S3403.

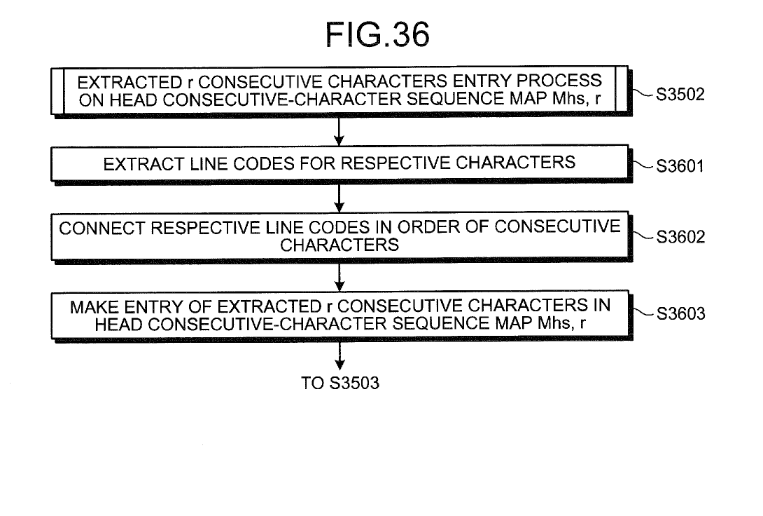

FIG. 36 is a flowchart of a first extracted r consecutive characters entry process (step S3502) on the head consecutive-character sequence map Mhs, r. This procedure applies when character codes for the extracted r consecutive characters are the JIS column/line code.

First, line codes are extracted from column/line codes for characters making up the extracted r consecutive characters (step S3601). The line codes are connected in the order of the consecutive characters to form a connected line code (step S3602). Then, an entry of the connected line code for the extracted r consecutive characters is made in the head consecutive-character sequence map Mhs, r (step S3603), after which the procedure flow proceeds to step S3503.

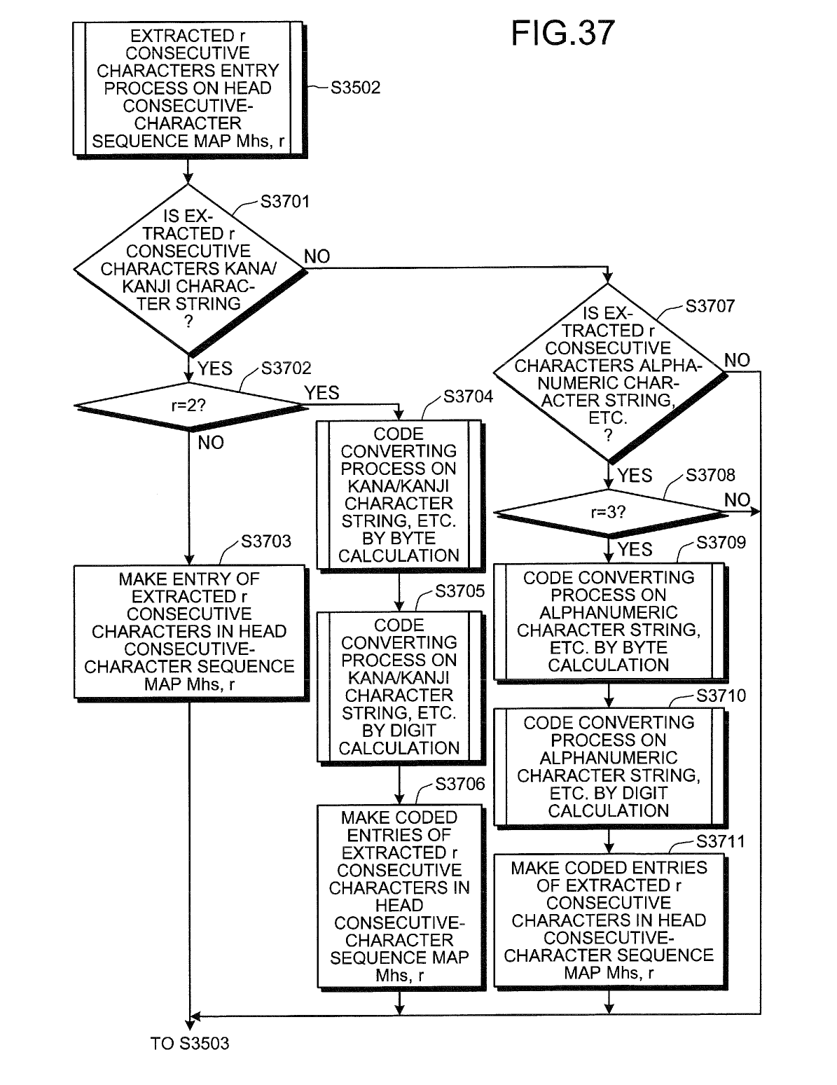

FIG. 37 is a flowchart of a second extracted r consecutive characters entry process (step S3502) on the head consecutive-character sequence map Mhs, r. This procedure applies when character codes for the extracted r consecutive characters are Unicode.

Whether the extracted r consecutive characters are a kana/kanji character string, etc. is determined (step S3701). When the consecutive characters are a kana/kanji character string, etc. (step S3701: YES), whether the number of characters r of the consecutive characters satisfies r=2 is determined (step S3702). When r=2 is not satisfied (step S3702: NO), an entry of the extracted r consecutive characters is made in the head consecutive-character sequence map Mhs, r (step S3703), after which the procedure flow proceeds to step S3503.

When r=2 is satisfied at step S3702 (step S3702: YES), a code converting process on the kana/kanji character string, etc. by byte calculation (step S3704) and a code converting process on the kana/kanji character string, etc. by digit calculation (step S3705) are executed in the manner depicted in FIG. 19. Then, as depicted in FIG. 20, entries of the coded extracted r consecutive characters are made in the head consecutive-character sequence map Mhs, r (step S3706), after which the procedure flow proceeds to step S3503.

When the extracted r consecutive characters are not a kana/kanji character string, etc. at step S3701 (step S3701: NO), whether the extracted r consecutive characters are an alphanumeric character string, etc. is determined (step S3707). When the consecutive characters are not an alphanumeric character string, etc. (step S3707: NO), the procedure flow proceeds to step S3503. When the consecutive characters are an alphanumeric character string, etc. (step S3707: YES), whether the number of characters r of the consecutive characters satisfies r=3 is determined (step S3708). When r=3 is not satisfied (step S3708: NO), the procedure flow proceeds to step S3503.

When r=3 is satisfied (step S3708: YES), a code converting process on the alphanumeric character string, etc. by byte calculation (step S3709) and a code converting process on the alphanumeric character string, etc. by digit calculation (step S3710) are executed in the manner depicted in FIG. 21. Then, as depicted in FIG. 22, entries of the coded extracted r consecutive characters are made in the head consecutive-character sequence map Mhs, r (step S3711), after which the procedure flow proceeds to step S3503.

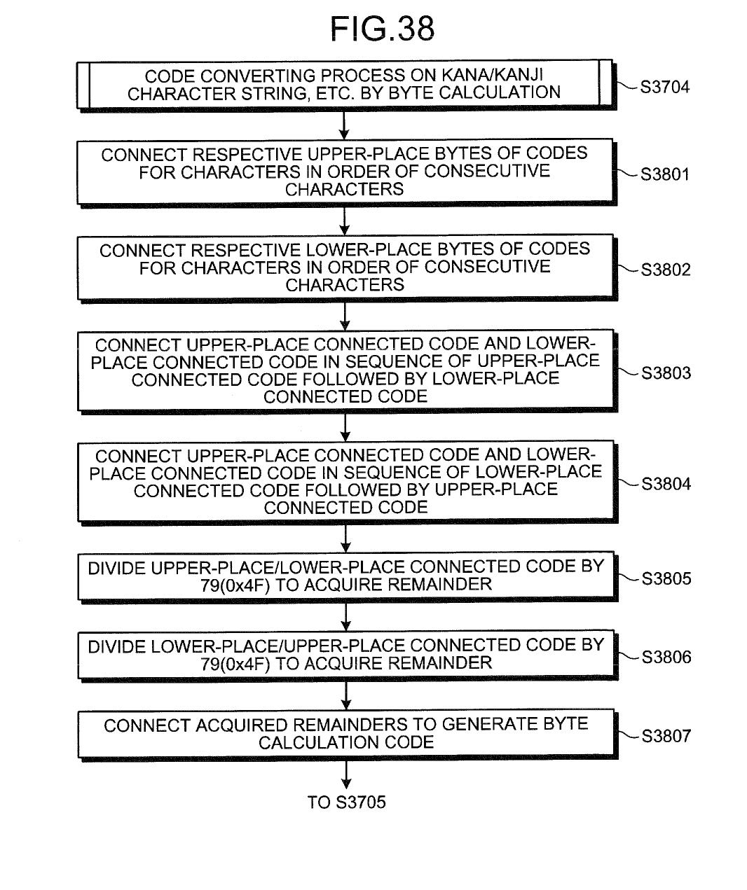

FIG. 38 is a flowchart of the code converting process on a kana/kanji character string, etc. by byte calculation (step S3704). First, as depicted in FIG. 19, respective upper-place bytes of codes for characters are connected in the order of consecutive characters to form an upper-place connected code (step S3801).

Then, respective lower-place bytes of the code for the character are connected in the order of the consecutive characters into a low-place connected code (step S3802). The upper-place connected code and the lower-place connected code are connected in the sequence of the upper-place connected code followed by the lower-place connected code to generate an upper-place/lower-place connected code (step S3803). Alternatively, the upper-place connected code and the lower-place connected code are connected in the sequence of the lower-place connected code followed by the upper-place connected code to generate a lower-place/upper-place connected code (step S3804).

The upper-place/lower-place connected code is then divided by 79(0x4F) to acquire a remainder (step S3805). The lower-place/upper-place connected code is also divided by 70 (0x4F) to acquire a remainder (step S3806). Subsequently, the acquired remainders are connected to generate a converted code by byte calculation (step S3807), after which the procedure flow proceeds to step S3705.

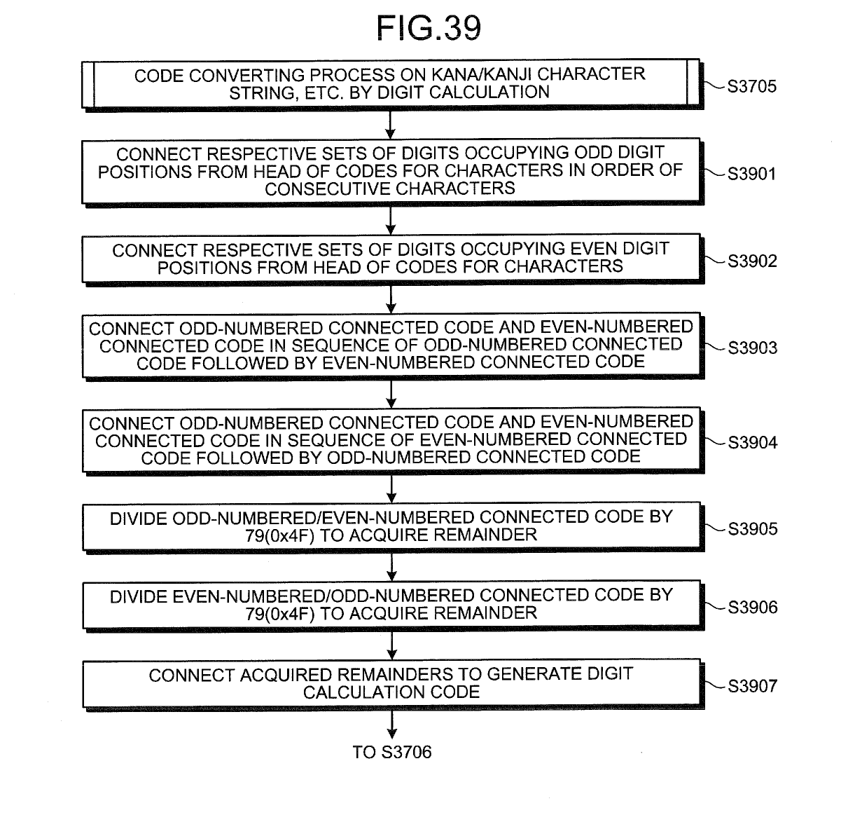

FIG. 39 is a flowchart of the code converting process on a kana/kanji character, etc. by digit calculation (step S3705). First, as depicted in FIG. 19, respective sets of digits occupying odd digit positions from the head of codes for characters are connected in the order of consecutive characters into an odd-numbered connected code (step S3901). Respective sets of digits occupying even digit positions from the head of the code for the characters are then connected in the order of the consecutive characters into an even-numbered connected code (step S3902).

Then, the odd-numbered connected code and the even-numbered connected code are connected in the sequence of the odd-numbered connected code followed by the even-numbered connected code to generate an odd-numbered/even-numbered connected code (step S3903). Alternatively, the odd-numbered connected code and the even-numbered connected code are connected in the sequence of the even-numbered connected code followed by the odd-numbered connected code to generate an even-numbered/odd-numbered connected code (step S3904).

The odd-numbered/even-numbered connected code is then divided by 79(0x4F) to acquire a remainder (step S3905). The even-numbered/odd-numbered connected code is also divided by 79(0x4F) to acquire a remainder (step S3906). Subsequently, the acquired remainders are connected to generate a converted code by digit calculation (step S3907), after which the procedure flow proceeds to step S3706.

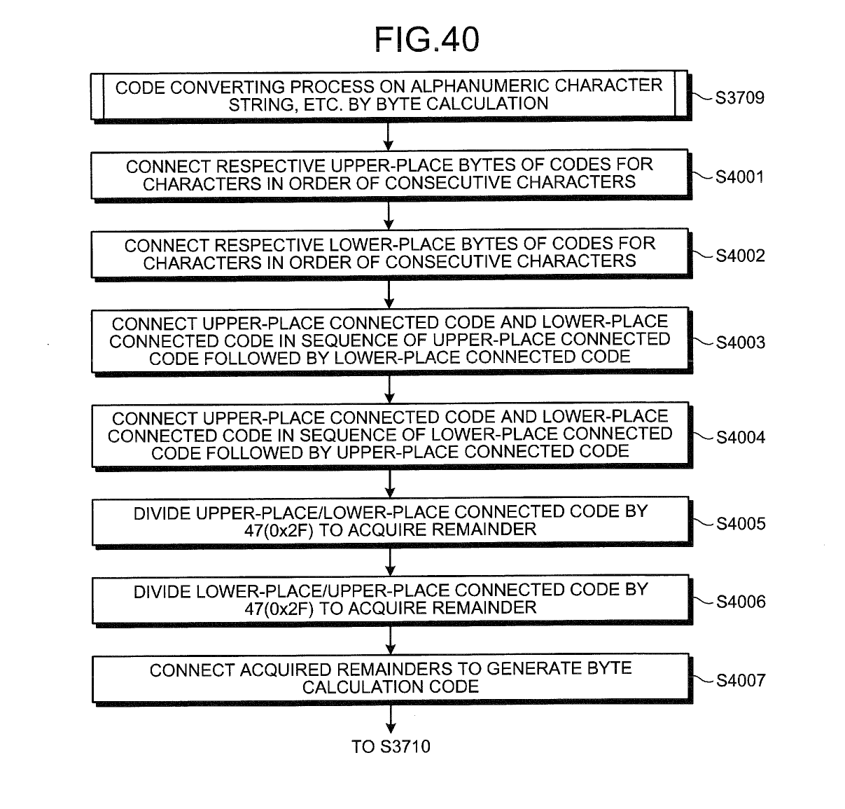

FIG. 40 is a flowchart of the code converting process on an alphanumeric character string, etc. by byte calculation (step S3709). As depicted in FIG. 21, respective upper-place bytes of codes for characters are connected in the order of consecutive characters into an upper-place connected code (step S4001).

Then, respective lower-place bytes of the codes for the characters are connected in the order of the consecutive characters into a low-place connected code (step S4002). The upper-place connected code and the lower-place connected code are connected in the sequence of the upper-place connected code followed by the lower-place connected code to generate an upper-place/lower-place connected code (step S4003). Alternatively, the upper-place connected code and the lower-place connected code are connected in the sequence of the lower-place connected code followed by the upper-place connected code to generate a lower-place/upper-place connected code (step S4004).

The upper-place/lower-place connected code is then divided by 47(0x2F) to acquire a remainder (step S4005). The lower-place/upper-place connected code is also divided by 47 (0x2F) to acquire a remainder (step S4006). Subsequently, the acquired remainders are connected to generate a converted code by byte calculation (step S4007), after which the procedure flow proceeds to step S3710.

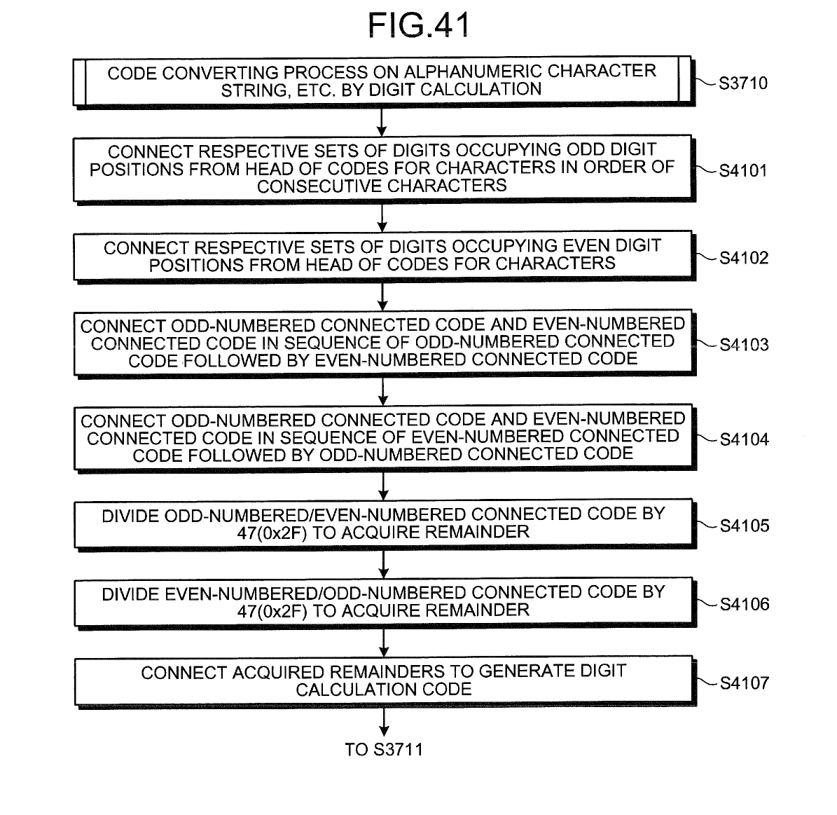

FIG. 41 is a flowchart of the code converting process on an alphanumeric character string, etc. by digit calculation (step S3710). As depicted in FIG. 21, respective sets of digits occupying odd digit positions from the head of codes for characters are connected in the order of consecutive characters into an odd-numbered connected code (step S4101). Respective sets of digits occupying even digit positions from the head of the codes for the characters are then connected in the order of the consecutive characters into an even-numbered connected code (step S4102).

Then, the odd-numbered connected code and the even-numbered connected code are connected in the sequence of the odd-numbered connected code followed by the even-numbered connected code to generate an odd-numbered/even-numbered connected code (step S4103). Alternatively, the odd-numbered connected code and the even-numbered connected code are connected in the sequence of the even-numbered connected code followed by the odd-numbered connected code to generate an even-numbered/odd-numbered connected code (step S4104).

The odd-numbered/even-numbered connected code is then divided by 47(0x2F) to acquire a remainder (step S4105). The even-numbered/odd-numbered connected code is also divided by 47(0x2F) to acquire a remainder (step S4106). Subsequently, the acquired remainders are connected to generate a converted code by digit calculation (step S4107), after which the procedure flow proceeds to step S3711.

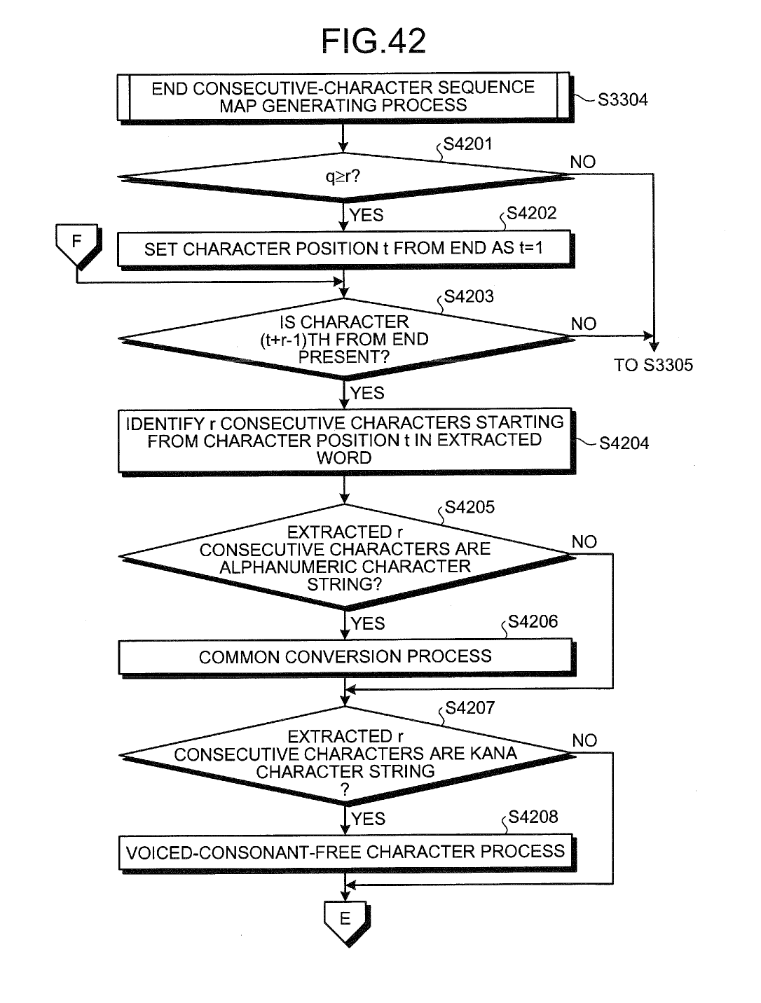

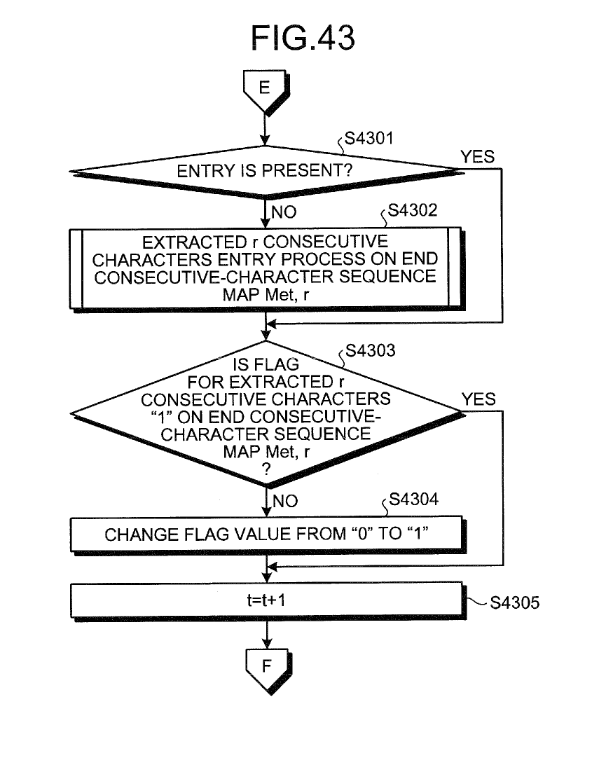

FIGS. 42 and 43 are flowcharts of the end consecutive-character sequence map generating process (step S3303). As depicted in FIG. 42, whether the number of characters q of an extracted word satisfies q≧r is determined (step S4201). When q≧r is not satisfied (step S4201: NO), the extracted word is equivalent to a single character or consecutive characters already entered on a map, so that the procedure flow proceeds to the end consecutive-character sequence map generating process (step S3305).

When q≧r is satisfied (step S4201: YES), a character position t from the end of the extracted word is set to 1 (step S4202), and whether a character (t+r−1)th from the end is present in the extracted word is determined (step S4203). When the character (t+r−1)th from the end is not present (step S4203: NO), no consecutive characters can be extracted from the extracted word, and the procedure flow proceeds to the end consecutive-character sequence map generating process (step S3305).

When the character (t+r−1)th from the end is present (step S4203: YES), r consecutive characters from the character position t are extracted from the extracted word (step S4204). Then, whether the extracted r consecutive characters are an alphanumeric character string is determined (step S4205). When the r consecutive characters are not an alphanumeric character string (step S4205: NO), the procedure flow proceeds to step S4207.

When the r consecutive characters are an alphanumeric character string (step S4205: YES), a common conversion process is executed by the converting unit 1605 (step S4206). Subsequently, whether the extracted r consecutive characters are a kana character string is determined (step S4207). When the r consecutive characters are not a kana character string (step S4207: NO), the procedure flow proceeds to step S4301 of FIG. 43. When the r consecutive characters are a kana character string (step S4207: YES), a voiced-consonant-free character process is executed by the converting unit 1605 (step S4208), after which the procedure flow proceeds to step S4301 of FIG. 43.

As depicted in FIG. 43, whether an entry of the extracted r consecutive characters is present in an end consecutive-character sequence map Met, r is determined (step S4301). When an entry is present already (step S4301: YES), the procedure flow proceeds to step S4303. When an entry is not present (step S4301: NO), an extracted r consecutive characters entry process on the end consecutive-character sequence map Met, r is executed (step S4302), after which the procedure flow proceeds to step S4303.

Then, whether a flag value for the file fi in the entry of the extracted r consecutive characters is “1” on the end consecutive-character sequence map Met, r is determined (step S4303). When the flag value is “1” (step S4303: YES), the procedure flow proceeds to step S4305. When the flag value is “0” (step S4303: NO), the flag value is changed from “0” to “1” (step S4304), and the character position t from the end is increased by 1 (step S4305), after which the procedure flow proceeds to step S4203.

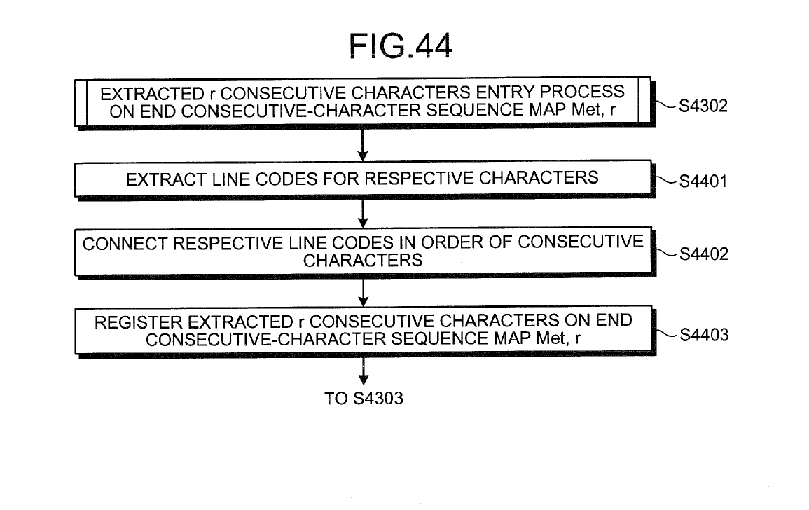

FIG. 44 is a flowchart of a first extracted r consecutive characters entry process (step S4302) on the end consecutive-character sequence map Met, r. This procedure applies when character codes for the extracted r consecutive characters are the JIS column/line code.

First, line codes are extracted from column/line codes for characters making up the extracted r consecutive characters (step S4401). The line codes are connected in the order of the consecutive characters to form a connected line code (step S4402). Then, an entry of the connected line code for the extracted r consecutive characters is made in the end consecutive-character sequence map Met, r (step S4403), after which the procedure flow proceeds to step S4303.

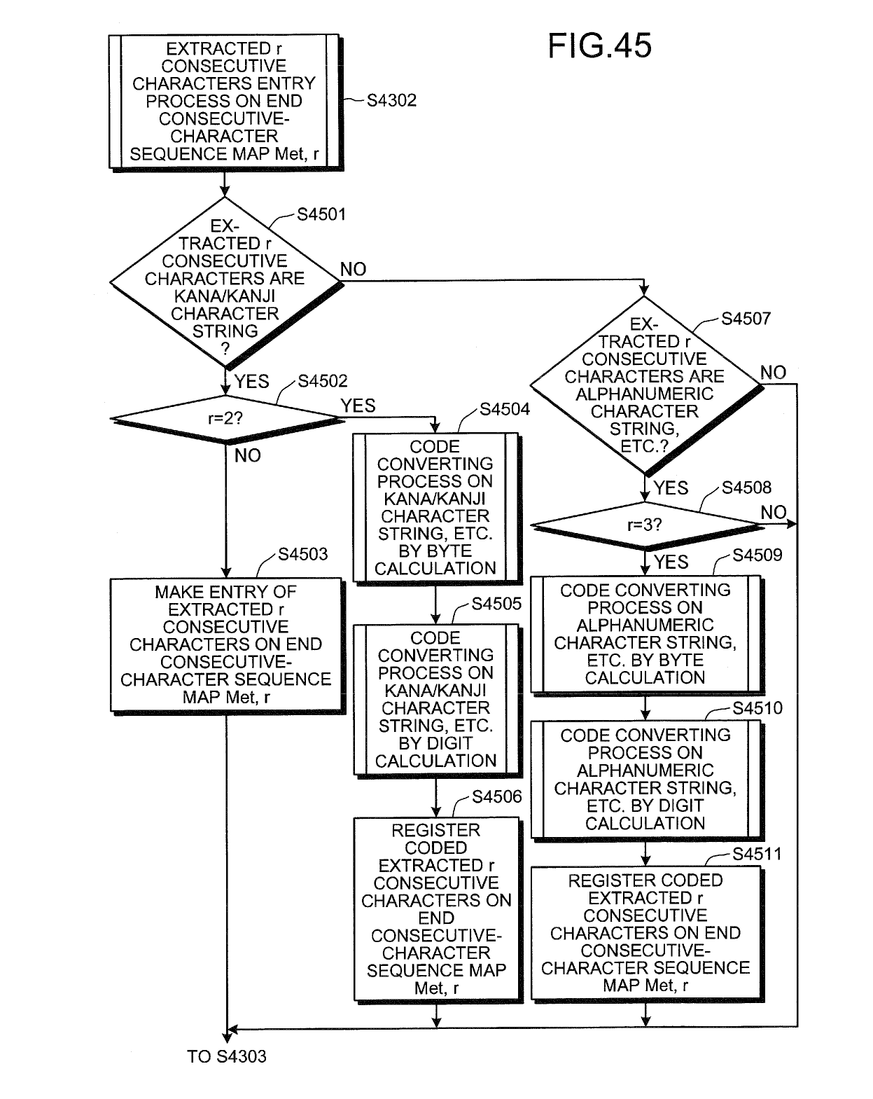

FIG. 45 is a flowchart of a second extracted r consecutive characters entry process (step S4302) on the end consecutive-character sequence map Met, r. This procedure applies when character codes for the extracted r consecutive characters are Unicode.

Whether the extracted r consecutive characters are a kana/kanji character string, etc. is determined (step S4501). When the consecutive characters are a kana/kanji character string, etc. (step S4501: YES), whether the number of characters r of the consecutive characters satisfies r=2 is determined (step S4502). When r=2 is not satisfied (step S4502: NO), an entry of the extracted r consecutive characters is made in the end consecutive-character sequence map Met, r (step S4503), after which the procedure flow proceeds to step S4303.

When r=2 is satisfied at step S4502 (step S4502: YES), a code converting process on the kana/kanji character string, etc. by byte calculation (step S4504) and a code converting process on the kana/kanji character string, etc. by digit calculation (step S4505) are executed in the manner depicted in FIG. 19.

The code converting process on the kana/kanji string, etc. by byte calculation at step S4504 is identical to the code converting process on the kana/kanji string, etc. by byte calculation at step S3704. Likewise, the code converting process on the kana/kanji string, etc. by digit calculation at step S4505 is identical to the code converting process on the kana/kanji string, etc. by digit calculation at step S3705.

As depicted in FIG. 20, entries of the coded extracted r consecutive characters are made on the end consecutive-character sequence map Met, r (step S4506), after which the procedure flow proceeds to step S4303.

When the extracted r consecutive characters are not a kana/kanji character string, etc. at step S4501 (step S4501: NO), whether the extracted r consecutive characters are an alphanumeric character string, etc. is determined (step S4507). When the consecutive characters are not an alphanumeric character string, etc. (step S4507: NO), the procedure flow proceeds to step S4303. When the consecutive characters are an alphanumeric character string, etc. (step S4507: YES), whether the number of characters r of the consecutive characters satisfies r=3 is determined (step S4508). When r=3 is not satisfied (step S4508: NO), the procedure flow proceeds to step S4303.

When r=3 is satisfied (step S4508: YES), the code converting process on the alphanumeric character string, etc. by byte calculation (step S4509) and the code converting process on the alphanumeric character string, etc. by digit calculation (step S4510) are executed in the manner depicted in FIG. 21.

The code converting process on the alphanumeric character string, etc. by byte calculation at step S4509 is identical to the code converting process on the alphanumeric character string, etc. by byte calculation at step S3709. Likewise, the code converting process on the alphanumeric character string, etc. by digit calculation at step S4510 is identical to the code converting process on the alphanumeric character string, etc. by digit calculation at step S3710.

As depicted in FIG. 22, entries of the coded extracted r consecutive characters are made on the end consecutive-character sequence map Met, r (step S4511), after which the procedure flow proceeds to step S4303.

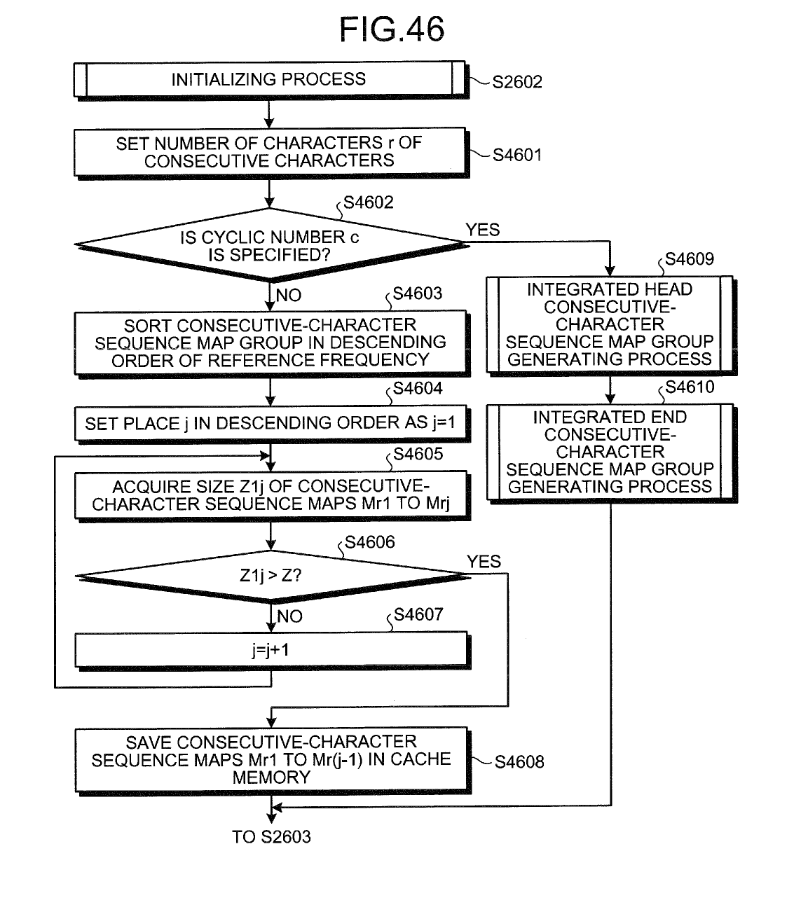

FIG. 46 is a flowchart of the initializing process (step S2602) of FIG. 26. First, the number of characters r of consecutive characters is set (step S4601), and whether a cyclic number c is specified is determined (step S4602). When the cyclic number c is not specified (step S4602: NO), a group of consecutive character sequence maps are sorted in the descending order of reference frequencies, based on the table of FIG. 25 (step S4603).

A place j in the descending order is set to 1 (step S4604), and the size Z1j of consecutive-character sequence maps Mr1 to Mrj is acquired (step S4605). In this process, whether the consecutive-character sequence map Mrj is the head consecutive-character sequence map Mhs, r or the end consecutive-character sequence map Met, r is not regarded.

Whether the acquired size Z1j satisfies Z1j>Z (allowable size in the cache memory) is determined (step S4606). When Z1j>Z is not satisfied (step S4606: NO), j is increased by 1 (step S4607), after which the procedure flow returns to step S4605. When Z1j>Z is satisfied (step S4606: YES), consecutive-character sequence maps Mr1 to Mr(j+1) are saved in the cache memory (step S4608). The procedure flow then proceeds to the input process (step S2603).

When the cyclic number c is specified at step S4602 (step 4602: YES), an integrated head consecutive-character sequence map group generating process (step S4609) and an integrated end consecutive-character sequence map group generating process (step S4610) are executed, after which the procedure flow proceeds to the input process (step S2603).

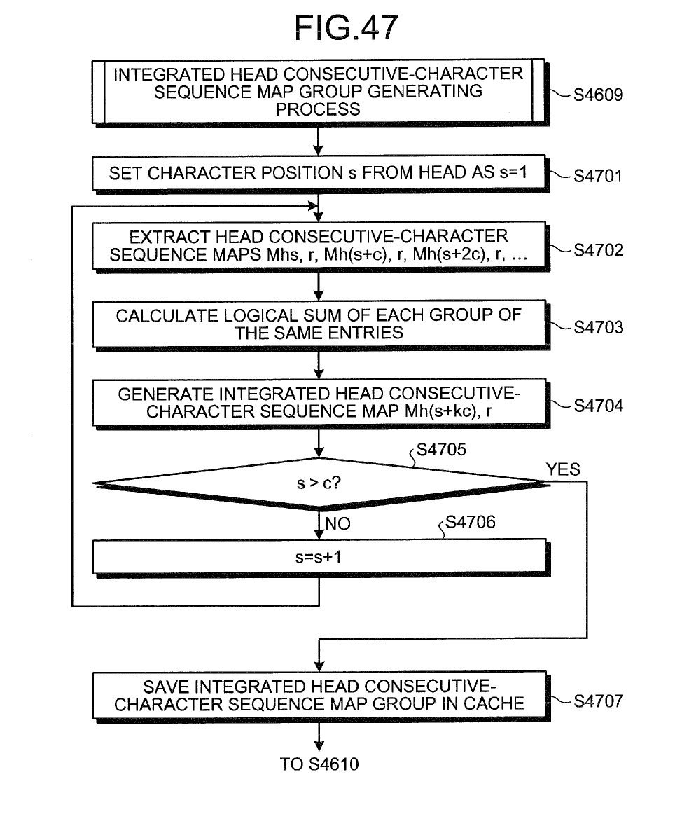

FIG. 47 is a flowchart of the integrated head consecutive-character sequence map group generating process (step S4609). As depicted in FIG. 47, a character position s from the head is set to 1 (step S4701), and, as depicted in FIG. 17, head consecutive-character sequence maps Mhs, r, Mh(s+c), r, Mh(s+2c), r, . . . are extracted from the head consecutive-character sequence map group Mh (step S4702).

Then, the logical sum of each group of the same entries on the maps is calculated (step S4703) to generate an integrated head consecutive-character sequence map Mh(s+kc), r (step S4704). Subsequently, whether the character position s satisfies s>c is determined (step S4705). When s>c is not satisfied (step S4705: NO), the character position s is increased by 1 (step S4706), after which the procedure flow returns to step S4702. When s>c is satisfied (step S4705: YES), an integrated head consecutive-character sequence map group is saved in the cache memory (step S4707). The procedure flow then proceeds to the integrated end consecutive-character sequence map group generating process (step S4610).

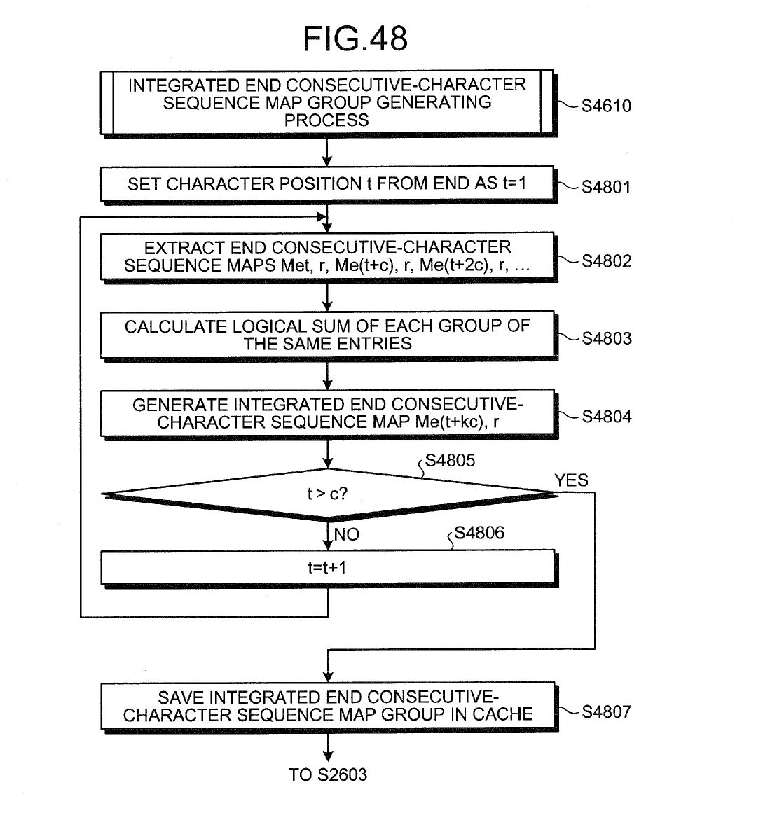

FIG. 48 is a flowchart of the integrated end consecutive-character sequence map group generating process (step S4610). As depicted in FIG. 48, a character position t from the end is set to 1 (step S4801), and, as depicted in FIG. 17, end consecutive-character sequence maps Met, r, Me(t+c), r, Me(t+2c), r, . . . are extracted from the end consecutive-character sequence map group Me (step S4802).

Then, the logical sum of each group of the same entries on the maps is calculated (step S4803) to generate an integrated end consecutive-character sequence map Me(t+kc), r (step S4804). Subsequently, whether the character position t satisfies t>c is determined (step S4805). When t>c is not satisfied (step S4805: NO), the character position t is increased by 1 (step S4806), after which the procedure flow returns to step S4802. When t>c is satisfied (step S4805: YES), an integrated end consecutive-character sequence map group is saved in the cache memory (step S4807). Subsequently, the procedure flow proceeds to the input process (S2603).

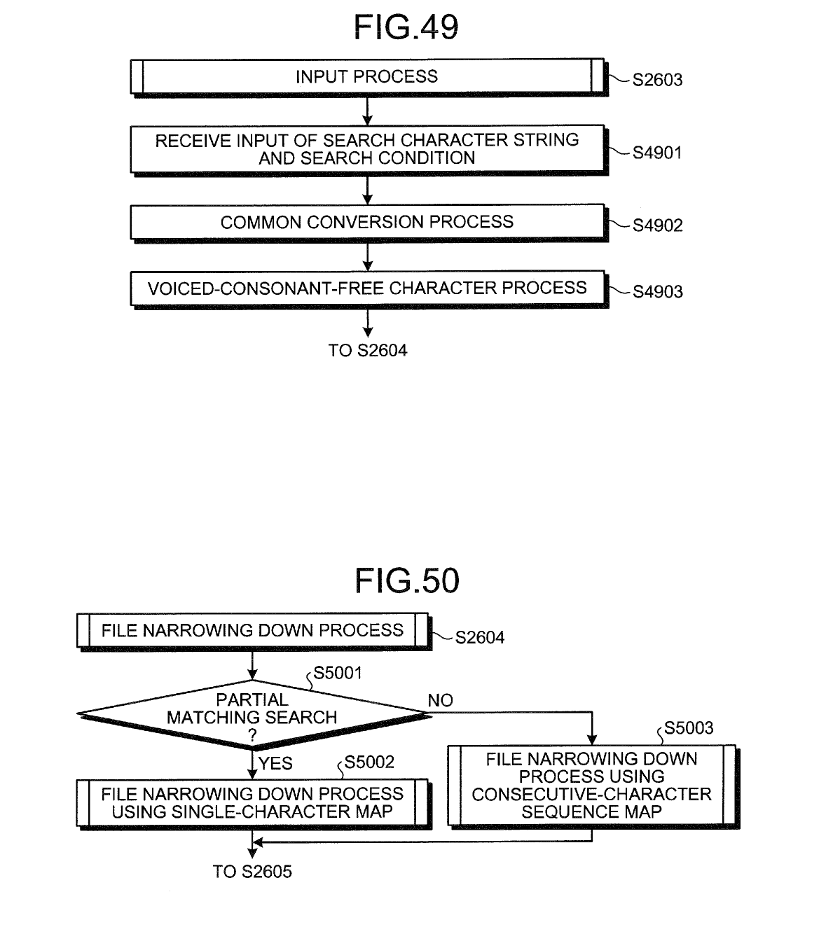

FIG. 49 is a flowchart of the input process (step S2603) of FIG. 26. First, input of a search character string and a search condition (forward matching, reverse matching, full matching, or partial matching) is received (step S4901). Then, the converting unit 2404 executes the common conversion process (step S4902) and the voiced-consonant-free character process (step S4903). The procedure flow then proceeds to the file narrowing down process (step S2604).

FIG. 50 is a flowchart of the file narrowing down process (step S2604). When the search condition is a partial matching search (step S5001: YES), the file narrowing down process using the single-character map M1 is executed (step S5002), after which the procedure flow proceeds to the search executing process (step S2605). When the search condition is not a partial matching search (step S5001: NO), the file narrowing down process using a consecutive-character sequence map is executed (step S5003), after which the procedure flow proceeds to the search executing process (step S2605).

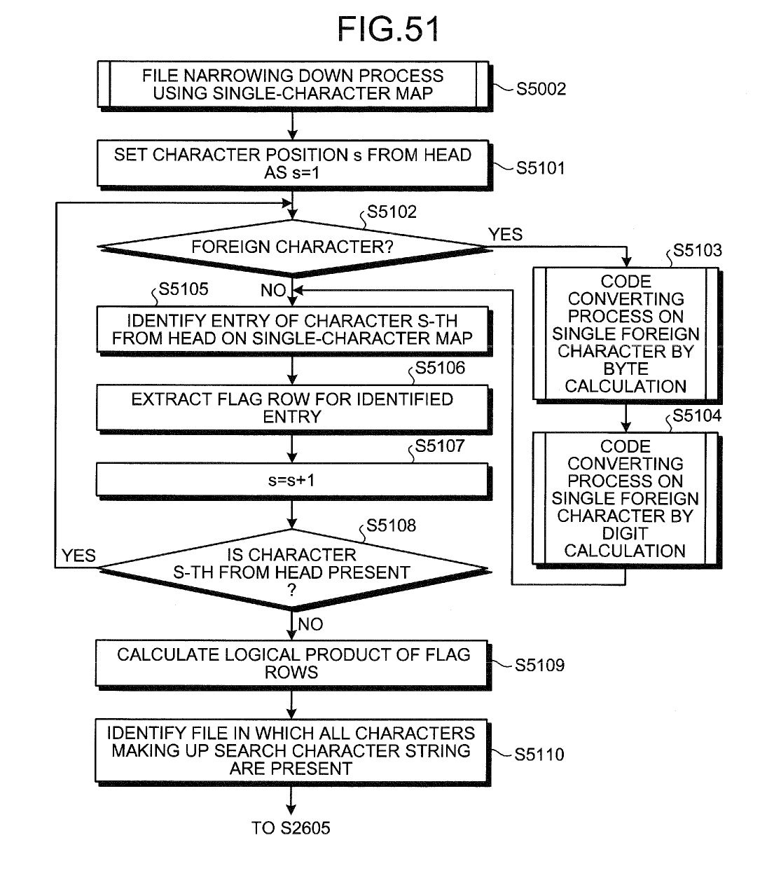

FIG. 51 is a flowchart of the file narrowing down process using the single-character map M1 (step S5002). First, a character position s from the head of a search character string is set to 1 (step S5101), and whether a character at the character position s is a foreign character is determined (step S5102). When the charter is a foreign character (step S5102: YES), a code converting process on a single foreign character by byte calculation (step S5103) and a code converting process on a single foreign character by digit calculation (step S5104) are executed, and the procedure flow proceeds to step S5105.

The code converting process on the single foreign character by byte calculation at step S103 is identical to the code converting process on the single foreign character by byte calculation at step S2906. Likewise, the code converting process on the single foreign character by digit calculation at step S5104 is identical to the code converting process on the single foreign character by digit calculation at step S2907.

When the charter is not a foreign character (step S5102: NO), an entry of a character s-th from the head is identified on the single-character map M1 (step S5105), and a flag row of the identified entry is extracted (step S5106). The character position s is then increased by 1 (step S5107), and whether a character s-th from the head is present is determined (step S5108).

When the character s-th from the head is present (step S5108: YES), the procedure flow proceeds to step S5102. When the s-th character is not present (step S5108: NO), the logical product of all of the extracted flag rows is calculated (step S5109). A file having a flag value of “1” as a result of the logical product calculation is identified as a file in which all characters making up the search character string are present (step S5110). The process flow then proceeds to the search executing process (step S2605).

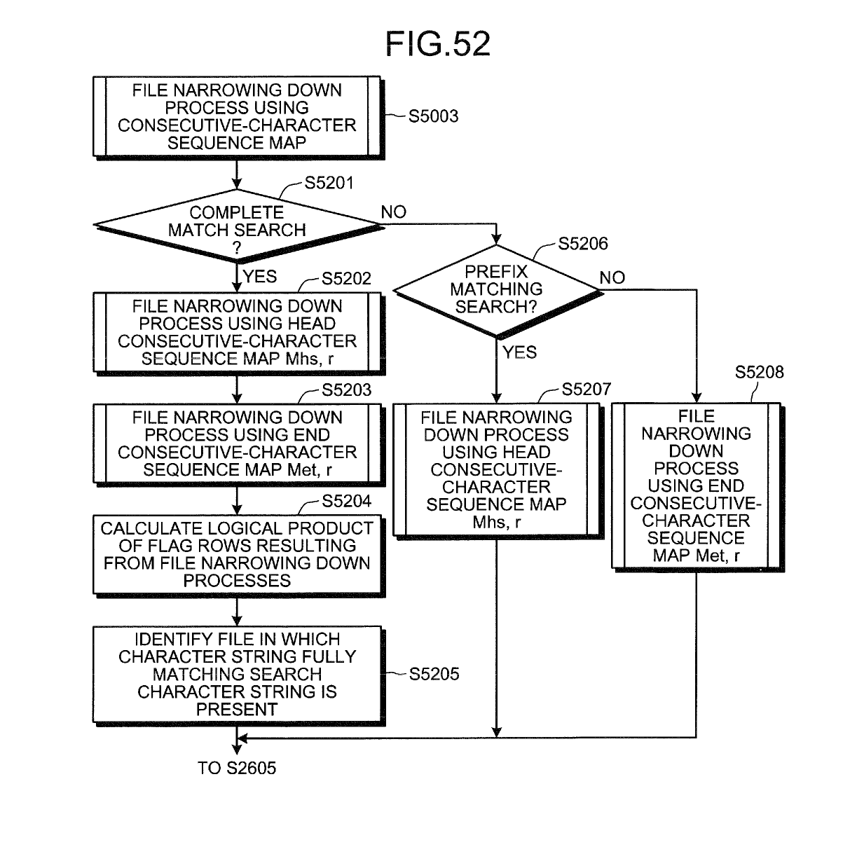

FIG. 52 is a flowchart of the file narrowing down process using a consecutive-character sequence map (step S5003). First, whether a search condition is complete-match search is determined (step S5201). When the search condition is complete-match search (step S5201: YES), the file narrowing down process using the head consecutive-character sequence map Mhs, r (step S5202) and the file narrowing down process using the end consecutive-character sequence map Met, r (step S5203) are executed.

Then, the logical product of flag rows resulting from the file narrowing down processes is calculated (step S5204). A file having a flag value of “1” as a result of the logical product calculation is determined to be a file in which a character string completely matching the search character string is present (step S5205). The process flow then proceeds to the search executing process (step S2605).

When the search condition is determined to be not complete-match search at step S5201 (step S5201: NO), whether the search condition is a forward-match search is determined (step S5206). When the search condition is a forward-match search (step S5206: YES), the file narrowing down process using the head consecutive-character sequence map Mhs, r (step S5207) is executed. This file narrowing down process is identical to the process executed at step S5202. Subsequently, the process flow proceeds to the search executing process (step S2605).

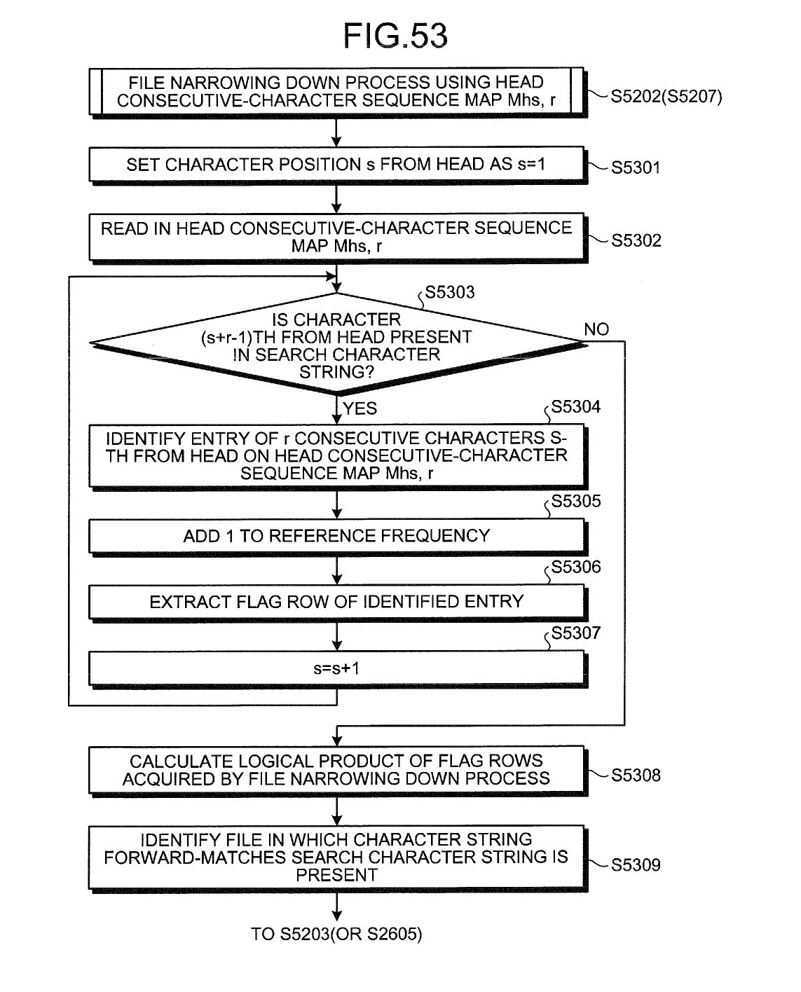

FIG. 53 is a flowchart of a first file narrowing down process using the head consecutive-character sequence map Mhs, r (step S5202 and S5207). First, a character position s from the head of a search character string is set to 1 (step S5301), and the head consecutive-character sequence map Mhs, r is read in (step S5302). Then, whether a character (s+r−1)th from the head is present in the search character string is determined (step S5303).

When the character (s+r−1)th from the head is present (step S5303: YES), an entry of r consecutive characters starting from s-th from the head is identified on the head consecutive-character sequence map Mhs, r (step S5304). Then, 1 is added to the reference frequency of the head consecutive-character sequence map Mhs, r (step S5305), and a flag row of the identified entry is extracted (step S5306). Subsequently, the character position s is increased by 1 (step S5307), after which the procedure flow proceeds to step S5303.

When the character (s+r−1)th from the head is not present (step S5303: NO), the logical product of flag rows acquired by the file narrowing down process is calculated (step S5308). A file having a flag value of “1” as a result of the logical product calculation is determined to be a file in which a character string matching the search character string in a forward direction is present (step S5309). The process flow then proceeds to the next process (step S5203 or S2605).

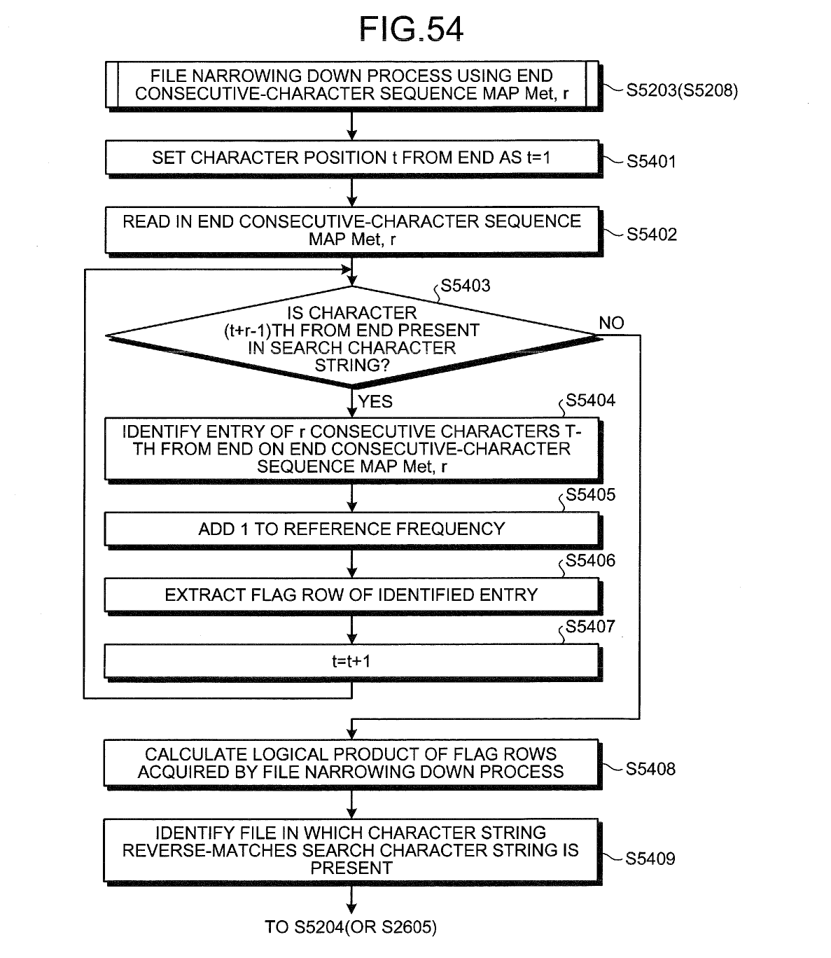

FIG. 54 is a flowchart of a first file narrowing down process using the end consecutive-character sequence map Met, r (step S5202 and S5208). First, a character position t from the end of a search character string is set to 1 (step S5401), and the end consecutive-character sequence map Met, r is read in (step S5402). Then, whether a character (t+r−1)th from the end is present in the search character string is determined (step S5403).

When the character (t+r−1)th from the end is present (step S5403: YES), an entry of r consecutive characters starting from s-th from the end is identified on the end consecutive-character sequence map Met, r (step S5404). Then, 1 is added to the reference frequency of the end consecutive-character sequence map Met, r (step S5405), and a flag row of the identified entry is extracted (step S5406). Subsequently, the character position t is increased by 1 (step S5407), after which the procedure flow proceeds to step S5403.

When the character (t+r−1)th from the end is not present (step S5403: NO), the logical product of flag rows acquired by the file narrowing down process is calculated (step S5408). A file having a flag value of “1” as a result of the logical product calculation is determined to be a file in which a character string matching the search character string in a reverse direction is present (step S5409). The process flow then proceeds to the next process (step S5204 or S2605).

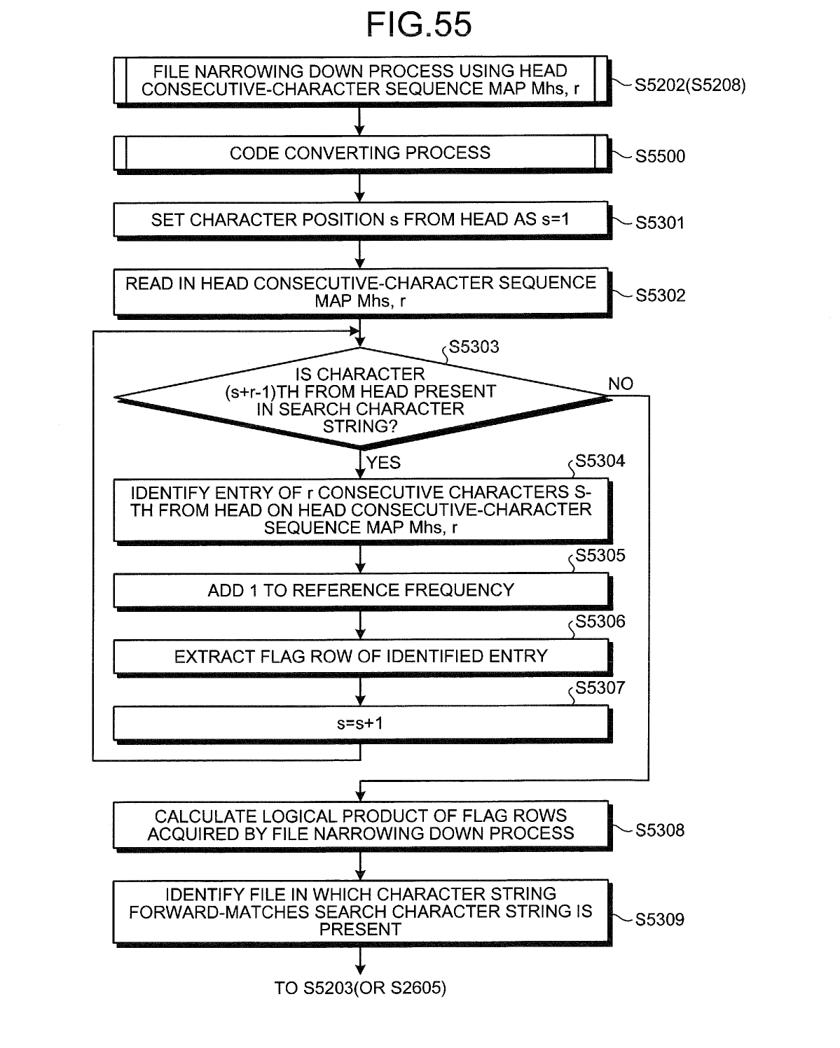

FIG. 55 is a flowchart of a second file narrowing down process using the head consecutive-character sequence map Mhs, r (step S5202 and S5207). In the second file narrowing down process using the head consecutive-character sequence map Mhs, r, the code converting process is executed by the converting unit 2404 (step S5500) before execution of steps S5301 to S5309.

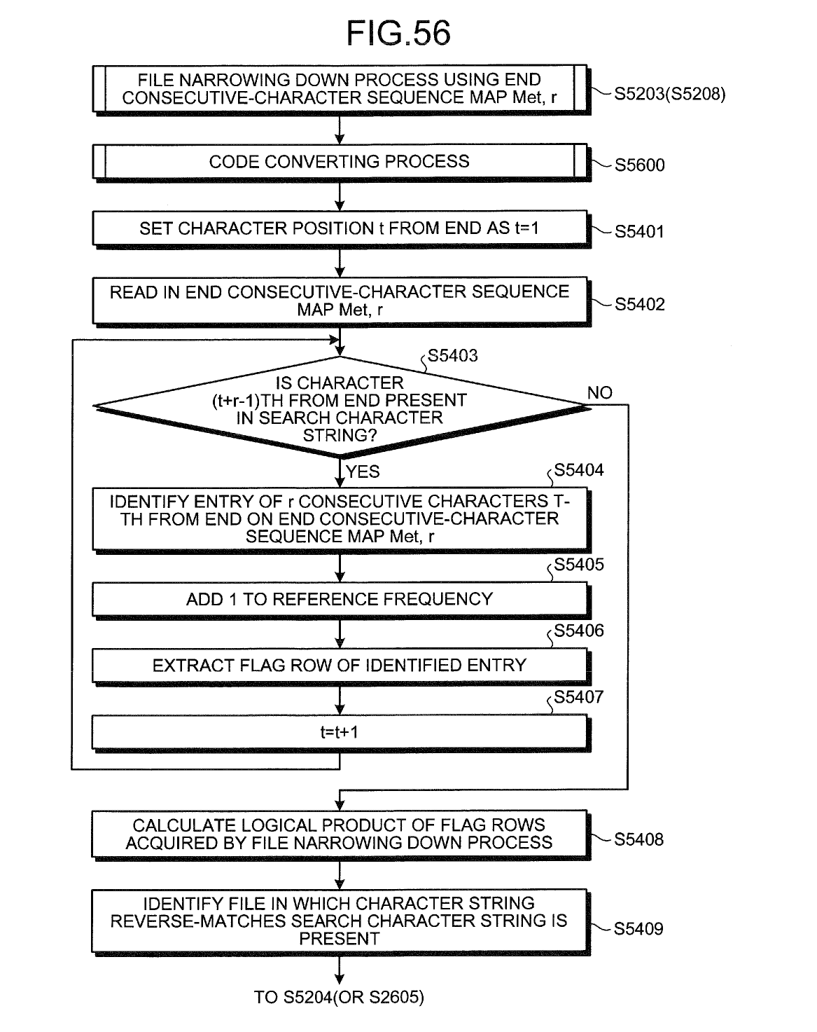

FIG. 56 is a flowchart of a second file narrowing down process using the end consecutive-character sequence map Met, r (step S5203 and S5208). In the second file narrowing down process using the end consecutive-character sequence map Met, r, the code converting process is executed by the converting unit 2404 (step S5600) before execution of steps S5401 to S5409.

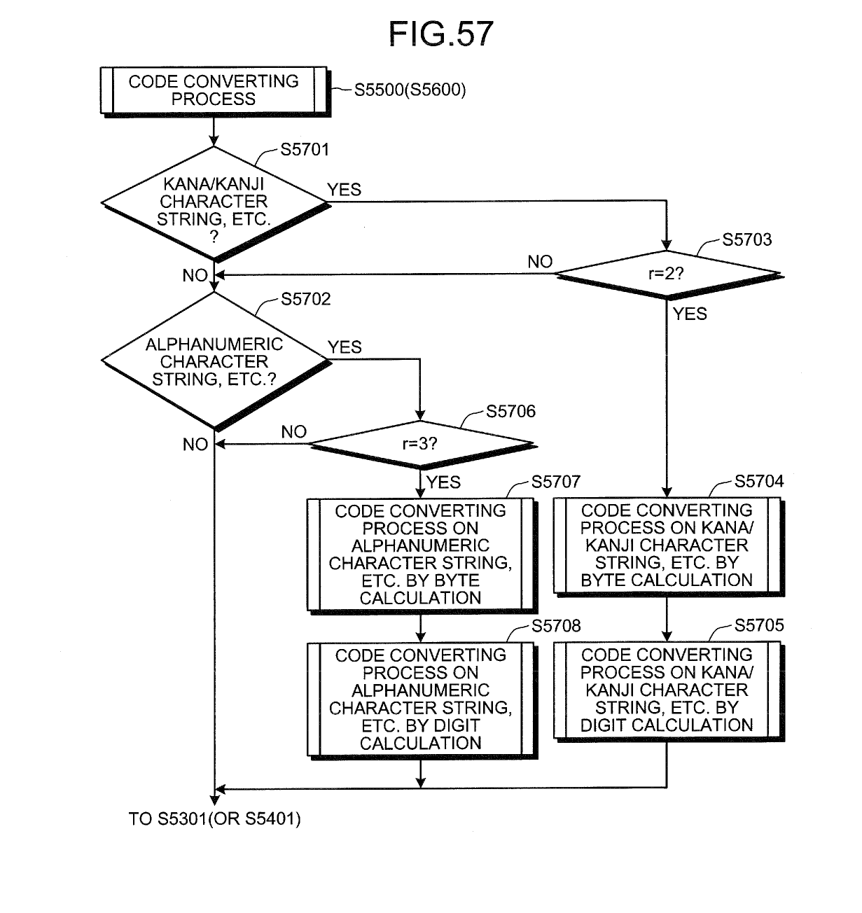

FIG. 57 is a flowchart of the code converting processes of FIGS. 55 and 56 (step S5500 and S5600). First, whether a search character string is a kana/kanji character string, etc. is determined (step S5701). When the search character string is not a kana/kanji character string, etc. (step S701: NO), whether the search character string is an alphanumerical character string, etc. is determined (step S5702). When the search character string is not an alphanumerical character string, etc. (step S5702: NO), the procedure flow proceeds to step S5301 (S5401).

When the search character string is a kana/kanji character string, etc. at step S5701 (step S701: NO), whether the number of characters r of consecutive characters satisfies r=2 is determined (step S5703). When r=2 is not satisfied (step S5703: NO), the procedure flow proceeds to step S5702. When r=2 is satisfied (step S5703: NO), the code converting process on the kana/kanji character string, etc. by byte calculation (step S5704) and the code converting process on the kana/kanji character string, etc. by digit calculation (step S5705) are executed, after which the procedure flow proceeds to step S5301 (S5401).

The code converting process on the kana/kanji character string, etc. by byte calculation (step S5704) is identical to the process executed at step S3704. Likewise, the code converting process on the kana/kanji character string, etc. by digit calculation (step S5705) is identical to the process executed at step S3705.

When the search character string is determined to be an alphanumeric character string, etc. at step S5702 (step S702: YES), whether the number of characters r of consecutive characters satisfies r=3 is determined (step S5706). When r=3 is not satisfied (step S5706: NO), the procedure flow proceeds to step S5301 (S5401). When r=3 is satisfied (step S5706: NO), the code converting process on the alphanumeric character string, etc. by byte calculation (step S5707) and the code converting process on the alphanumeric character string, etc. by digit calculation (step S5708) are executed, after which the procedure flow proceeds to step S5301 (S5401).

The code converting process on the alphanumeric character string, etc. by byte calculation (step S5707) is identical with the process executed at step S3709. Likewise, the code converting process on the alphanumeric character string, etc. by digit calculation (step S5708) is identical with the process executed at step S3710. In this manner, a code for a search character string is converted in correspondence to a converted code on a consecutive-character sequence map. This establishes the corresponding relation between the consecutive-character sequence map and the search character string.

According to the above embodiment, the consecutive-character sequence map group Mhe is generated for an alphanumeric word, a kana word, and a katakana word, thereby improving the probability of narrowing down to-be-searched files and increasing the speed of full text search. Specifically, a decrease in the probability of connection of characters in a string of characters making up a word is utilized to achieve high-speed search by narrowing down to-be-searched files using the consecutive-character sequence map group Mhe.

The head consecutive-character sequence map group Mh, the end consecutive-character sequence map group Me, and both map groups Me and Mh are used for forward-match search, reverse-match search, and complete-match search, respectively. This improves the probability of narrowing down to-be-searched files and increases search speed. A consecutive-character sequence map corresponding to the character position of each of characters making up an input search character string is used to improve the probability of narrowing down files to be searched.

While a case of searching the file fi in the contents 210 is described in the above embodiment, the keyword data 211 may be searched for a search character string matching.

Adopting common code notation for alphanumeric characters, kana characters, and katakana characters reduces the size of the consecutive-character sequence map group Mhe. If a word composed of numbers of characters is included in a file, consecutive-character sequence maps corresponding to the character positions of numbers of characters are generated to increase a map size. Giving the consecutive-character sequence map group Mhe a cyclic structure, however, allows sequence map generation corresponding to a word composed of numbers of characters, thus enables optimization of the total size of the consecutive-character sequence map group Mhe.

Types of kanji characters amount to 5,000 to 8,000 types. To enable the consecutive-character sequence map group Mhe to reside in the cache memory, a character code string for consecutive characters is generated using line codes for kanji/kana characters in recognition of the advantage of the line code of the JIS column/line code. This reduces a character code string for kana/kanji consecutive characters in length to be shorter than the original code string for the kana/kanji consecutive characters, thus suppresses an increase in map size.

A word composed of plural phrases is divided to improve comprehensiveness in entry of consecutive characters on the consecutive-character sequence map group Mhe. In the execution of a search, files to be searched are narrowed down through consecutive characters comprehensively entered on maps. This improves the probability of file narrowing down and increases search speed.

With a new technical term and a newly-coined word added to keyword data and a file, the map generating apparatus 201 updates the consecutive-character sequence map group Mhe. This enables customization in the search operation.

The frequency of reference to the consecutive-character sequence map group Mhe is counted at the time of search, so that a consecutive-character sequence map accessed frequently is loaded at the initial stage to be stationed permanently on the cache. This increases the speed of full text search.

In the above embodiment, a kana/kanji character string, etc. of two consecutive characters is converted into two types of codes, and a flag row is set for each of two converted codes for the kana/kanji character string, etc. of two consecutive characters. As a result, files to be searched are narrowed down to hit files through logical product calculation (crossover processing) on both flag rows when full text search on files f0 to fn is performed. This improves the probability of file narrowing down.

An alphanumeric character string, etc. of three consecutive characters is converted into two types of codes, and a flag row is set for each of the converted codes for the alphanumeric character string, etc. of three consecutive characters. As a result, keywords are narrowed down to hit keywords through logical product calculation (crossover processing) on both flag rows when keyword search on the keyword data 211 is performed. This improves the probability of narrowing down keywords.

As set forth hereinabove, according to this embodiment, the precision of file narrowing down is improved, using a consecutive-character sequence map, to increase the speed of full text search.

The method explained in the present embodiment can be implemented by a computer, such as a personal computer and a workstation, executing a program that is prepared in advance. The program is recorded on a computer-readable recording medium such as a hard disk, a flexible disk, a CD-ROM, an MO, and a DVD, and is executed by being read out from the recording medium by a computer. The program can be a transmission medium that can be distributed through a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A searching apparatus comprising:
a word extracting unit that extracts a word that includes a plurality of characters, from a plurality of files that include character strings written therein, the character strings including keywords;
a consecutive-character extracting unit that extracts consecutive characters of a given number from a given position of the word extracted by the word extracting unit;
a judging unit that judges for each of the consecutive characters extracted by the consecutive-character extracting unit and based on information that correlates each of the keywords included in the files and a file that includes the keyword, whether the consecutive characters matches any of the keywords included in the information;
a generating unit that generates for each of the consecutive characters judged to match the keyword by the judging unit, a consecutive-character sequence map that includes flag rows indicating whether the consecutive characters are included in each of the files; and
a determining unit that determines, when a keyword for which a search is requested is searched for from among the files and based on the consecutive-character sequence map generated by the generating unit, a file that includes a keyword that matches the keyword for which the search is requested.

2. A generating apparatus comprising:
a word extracting unit that extracts a word that includes a plurality of characters, from a plurality of files that include character strings written therein, the character strings including keywords;
a consecutive-character extracting unit that extracts consecutive characters of a given number from a given position of the word extracted by the word extracting unit;
a judging unit that judges for each of the consecutive characters extracted by the consecutive-character extracting unit and based on information that correlates each of the keywords included in the files and a file that includes the keyword, whether the consecutive characters matches any of the keywords included in the information; and
a generating unit that generates for each of the consecutive characters judged to match the keyword by the judging unit, a consecutive-character sequence map that includes flag rows indicating whether the consecutive characters are included in each of the files.

3. A non-transitory computer-readable recording medium that stores therein a searching program that causes a computer to execute a process comprising:
extracting a word that includes a plurality of characters, from a plurality of files that include character strings written therein, the character strings including keywords;
extracting consecutive characters of a given number from a given position of the word extracted at the extracting;
judging for each of the consecutive characters extracted at the extracting and based on information that correlates each of the keywords included in the files and a file that includes the keyword, whether the consecutive characters matches any of the keywords included in the information;
generating for each of the consecutive characters judged to match the keyword at the judging, a consecutive-character sequence map that includes flag rows indicating whether the consecutive characters are included in each of the files; and
determining, when a keyword for which a search is requested is searched for from among the files and based on the consecutive-character sequence map generated at the generating, a file that includes a keyword that matches the keyword for which the search is requested.

4. A non-transitory computer-readable recording medium that stores therein a generating program that causes a computer to execute a process comprising:
extracting a word that includes a plurality of characters, from a plurality of files that include character strings written therein, the character strings including keywords;
extracting consecutive characters of a given number from a given position of the word extracted at the extracting;
judging for each of the consecutive characters extracted at the extracting and based on information that correlates each of the keywords included in the files and a file that includes the keyword, whether the consecutive characters matches any of the keywords included in the information; and
generating for each of the consecutive characters judged to match the keyword at the judging, a consecutive-character sequence map that includes flag rows indicating whether the consecutive characters are included in each of the files.

5. A searching method that causes a computer to execute a process comprising:
extracting a word that includes a plurality of characters, from a plurality of files that include character strings written therein, the character strings including keywords;
extracting consecutive characters of a given number from a given position of the word extracted at the extracting;
judging for each of the consecutive characters extracted at the extracting and based on information that correlates each of the keywords included in the files and a file that includes the keyword, whether the consecutive characters matches any of the keywords included in the information;
generating for each of the consecutive characters judged to match the keyword at the judging, a consecutive-character sequence map that includes flag rows indicating whether the consecutive characters are included in each of the files; and
determining, when a keyword for which a search is requested is searched for from among the files and based on the consecutive-character sequence map generated at the generating, a file that includes a keyword that matches the keyword for which the search is requested.

6. A generating method that causes a computer to execute a process comprising:
extracting a word that includes a plurality of characters, from a plurality of files that include character strings written therein, the character strings including keywords;
extracting consecutive characters of a given number from a given position of the word extracted at the extracting;
judging for each of the consecutive characters extracted at the extracting and based on information that correlates each of the keywords included in the files and a file that includes the keyword, whether the consecutive characters matches any of the keywords included in the information; and
generating for each of the consecutive characters judged to match the keyword at the judging, a consecutive-character sequence map that includes flag rows indicating whether the consecutive characters are included in each of the files.
